(19) United States
(12) Patent Application Publication
(10) Pub. No.: US 2011/0032807 A1
(43) Pub. Date: Feb. 10, 2011

(54) OPTICAL PICKUP DEVICE AND OPTICAL DISK DEVICE INCLUDING THE SAME

(75) Inventor: Tetsuo SAEKI, Osaka-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 12/846,512

(22) Filed: Jul. 29, 2010

(30) Foreign Application Priority Data
Aug. 5, 2009 (JP) 2009-182216

(51) Int. Cl. G11B 20/00; G11B 7/135

(52) U.S. Cl. 369/47.15; 369/112.05; G9B/7.112; G9B/20

(57) ABSTRACT

An optical pickup device is provided. In an optical pickup device, a light receiving element has light receiving regions for focusing as part of the plurality of light receiving regions. A diffraction element has diffraction regions for focusing as part of the plurality of diffraction regions. A part of division lines which define the diffraction region for focusing is formed in a shape which is convex from the outer side toward the inner side with respect to the center of the incidence range on the diffraction element where a returning light beam enters. The part of the division lines formed in the shape which is convex from the outer side toward the inner side divides an incidence range on the diffraction element where a returning light beam enters, regardless of whether or not there is a focus error.

### CROSS-REFERENCE TO RELATED APPLICATION

This application claims priority to Japanese Patent Application No. 2009-182216, which was filed on Aug. 5, 2009, the contents of which are incorporated herein by reference in its entirety.

### BACKGROUND OF THE INVENTION

1. Field of the Invention

The present invention relates to an optical pickup device which irradiates light onto a recording layer of an optical disk and to an optical disk device which includes an optical pickup device and performs at least one of reproduction, recording, rewriting, and deletion of the information with respect to the optical disk.

2. Description of the Related Art

There has been known a device which performs focusing servo using a double knife edge method, as an optical pickup device of related art. In this device, the section of a spot of light beams entering a diffraction element increases or decreases in diameter as a focus error increases or decreases. In the double knife edge method, part of ± first-order diffracted light beams are used for focusing servo among light beams which are diffracted by the diffraction element and are emitted from the diffraction element. A plurality of diffraction regions are formed in the diffraction element, and part of the plurality of diffraction regions serve as diffraction regions from which ± first-order diffracted light beams used for focusing servo are emitted. That is, part of the plurality of diffraction regions are used for focusing servo.

The ratio of the light intensity of light beam, which enters the diffraction region used for focusing servo, to the light intensity of a whole spot of light beams entering the diffraction element changes with the diameter of the spot on the diffraction element.

For Example, an optical pickup device in the related art disclosed in JP-A 2008-192251 includes an optical integration unit. The optical integration unit in the related art includes a semiconductor laser chip which emits light toward a two-layer optical disk; a polarization hologram which makes a returning light beam from the two-layer optical disk branch into a zeroth-order diffracted light beam and ± first-order diffracted light beams by diffraction; an optical detector which receives the zeroth-order diffracted light beam and the ± first-order diffracted light beams; and a light branching element which guides the diffracted light from the polarization hologram to the optical detector. In this technique, the polarization hologram is a diffraction element.

FIG. 11 is a plan view showing a polarization hologram 3 in the related art. FIG. 12 is a plan view showing a diffraction element and a light receiving element when an objective lens has come close to a two-layer optical disk in the optical pickup device in the related art. A first light receiving section which receives the zeroth-order diffracted light beam from the polarization hologram 3 and a second light receiving section which receives the ± first-order diffracted light beams from the polarization hologram 3 are formed in an optical detector 5. A plurality of light receiving regions are formed in each of the first and second light receiving sections.

The semiconductor laser chip is provided on one surface of a stem 6, which is formed in a plate shape, in a direction perpendicular to the thickness direction. As an example of the semiconductor laser chip, a semiconductor laser chip that emits red light, which has an oscillation wavelength near 650 nm used for recording and reproduction of the information with respect to a DVD, may be mentioned. However, it is not particularly limited thereto. For example, a semiconductor laser chip that emits purple-blue light which has an oscillation wavelength near 405 nm corresponding to a Blu-ray disk, a semiconductor laser chip that emits red light which has an oscillation wavelength near 780 nm corresponding to a CD, and the like may also be mentioned. The semiconductor laser chip is equivalent to a light source.

The polarization hologram 3 is provided on one surface of a glass substrate in its thickness direction, and the glass substrate is provided on the light branching element. The polarization hologram 3 is an element which selectively performs transmission or diffraction of light by a polarization direction. The polarization hologram 3 allows emitted light, which is linearly polarized light in a radial direction X that is emitted from the semiconductor laser chip toward the two-layer optical disk, to be transmitted therethrough and makes a returning light beam, which is reflected by the two-layer optical disk and is then converted into linearly polarized light in a track direction Y by a ¼ wavelength plate, branch off by diffraction.

The polarization hologram 3 is divided into a first diffraction region 9, a second diffraction region 10, and other regions by three division lines 11, 12, and 13 parallel to the radial direction X. Among the three division lines parallel to the radial direction X, the second division line 12 is formed in the middle of the track direction Y of the polarization hologram 3, the first division line 11 is formed closer to one track direction Y1 than the second division line 12 is, and the third division line 13 is formed closer to the other track direction Y2 than the second division line 12 is.

The region, which is located closer to the other track direction Y2 than the third division line 13 is, is divided into two diffraction regions by a fourth division line 14 extending in the radial direction X. The region, which is located closer to the one track direction Y1 than the first division line 11, is divided into two diffraction regions by a fifth division line 15 extending in the radial direction X. The diffraction region formed between the first and second division lines 11 and 12 is assumed to be the “first diffraction region” 9, and a diffraction region formed between the second and third division lines 12 and 13 is assumed to be the “second diffraction region” 10. Between the two diffraction regions formed by being divided by the fourth division line 14, the diffraction region located at the other radial direction X2 is assumed to be a “third diffraction region” 16 and the diffraction region located at one radial direction X1 is assumed to be a “fourth diffraction region” 17. Between the two diffraction regions formed by being divided by the fifth division line 15, the diffraction region located at the other radial direction X2 is assumed to be a “fifth diffraction region” 18 and the diffraction region located at the one radial direction X1 is assumed to be a “sixth diffraction region” 19. The ± first-order diffracted light beams which are diffracted after entering the first and second diffraction regions 9 and 10 among the plurality of diffraction regions formed in a diffraction element is used for focusing.

The optical integration unit in the related art includes a light receiving element. The light receiving element is provided on one surface of a stem in one side of a thickness direction Z. The first and second light receiving sections are photoelectric conversion elements realized by photodiodes, for example, and detect a signal of a pit formed on a two-layer optical disk by converting the light intensity into an electrical signal by photoelectric conversion based on the received light. In the light receiving element in the related art, the first light receiving section is provided in the middle when the light receiving element is viewed from the thickness direction Z. A plurality of light receiving regions included in the second light receiving section are formed so as to be separated from each other in the radial direction X and the track direction Y with the first light receiving section in the middle.

The ± first-order diffracted light beams diffracted in the first and second diffraction regions 9 and 10 of the diffraction element enter the first to fourth light receiving regions included in the second light receiving section. Between the ± first-order diffracted light beams, the + first-order diffracted light beam enters the first and second light receiving regions and the − first-order diffracted light beam enters the third and fourth light receiving regions. When there is no error in focusing, that is, when the distance between an objective lens and a recording layer of a two-layer optical disk is an optimal value, the + first-order diffracted light beam enters the vicinity of the borderline of the first and second light receiving regions with a minimum spot diameter. In addition, the − first-order diffracted light beam enters the vicinity of the borderline of the third and fourth light receiving regions with a minimum spot diameter. Hereinafter, this state is called an “optimal state” regarding the distance between an objective lens and a recording layer of a two-layer optical disk, the spot diameter of returning light beam entering a diffraction element, and the spot diameter of light beams entering each light receiving region.

FIG. 12 shows a diffraction element and a light receiving element when the distance between an objective lens and a recording layer of a two-layer optical disk is smaller than the optimal value. When a focus error occurs, that is, when the distance between the objective lens and the recording layer of the two-layer optical disk is larger or smaller than the optimal value, the + first-order diffracted light beam enters the position deviated from the vicinity of the borderline of the first and second light receiving regions as a spot larger than the minimum spot diameter. In addition, the − first-order diffracted light beam enters the position deviated from the vicinity of the borderline of the third and fourth light receiving regions as a spot larger than the minimum spot diameter.

If the distance between the objective lens and the recording layer of the two-layer optical disk is smaller than the optimal value when a focus error occurs, a spot diameter C1 of light beams entering the diffraction region becomes larger than a spot diameter C2 in the optimal state. Accordingly, the light beams entering the diffraction region spread to the third to sixth diffraction regions 16, 17, 18, and 19 through the first and second diffraction regions 9 and 10.

Accordingly, the spot of light which reaches a light receiving element after being diffracted in each of the first and second diffraction regions 9 and 10 becomes a spot with a shape which is close to a trapezoid defined by a diameter and a chord parallel to the diameter and in which a part is missing from a semicircular shape. Hereinafter, this state is called a “near state” regarding the distance between the objective lens and the recording layer of the two-layer optical disk, the spot diameter of returning light beam entering the diffraction element, and the spot diameter of light beams entering each light receiving region.

FIG. 13 is a plan view showing a diffraction element and a light receiving element when an objective lens has become distant from a two-layer optical disk in the optical pickup device in the related art. Specifically, FIG. 13 shows a diffraction element and a light receiving element when the distance between the objective lens and the recording layer of the two-layer optical disk is larger than the optimal value. If the distance between the objective lens and the recording layer of the two-layer optical disk is larger than the optimal value when a focus error occurs, a spot diameter C3 of light beams entering the diffraction region becomes smaller than the spot diameter C2 in the optimal state. For this reason, the light beams entering the diffraction region reach only the first and second diffraction regions 9 and 10.

Accordingly, an incidence range of the light beams does not spread to the third to sixth diffraction regions 16, 17, 18, and 19, and the spot of light, which reaches a light receiving element after being diffracted in each of the first and second diffraction regions 9 and 10, becomes a semicircular spot. Hereinafter, this state is called a “far state” regarding the distance between the objective lens and the recording layer of the two-layer optical disk, the spot diameter of returning light beam entering the diffraction element, and the spot diameter of light beams entering each light receiving region.

An optical pickup device in the related art further includes a computing unit. The computing unit is electrically connected to each of the light receiving regions included in the first and second light receiving elements of the light receiving element, and performs calculation on the basis of output signals outputted from the light receiving regions to generate signals, such as a main push-pull signal, a focus error signal, an objective lens shift signal, and a tracking error signal.

In the related art, there is a problem that ± first-order diffracted light beams diffracted in the first and second diffraction regions 9 and 10 are not detected by the light receiving element or a difference occurs between the amount of change in the signal strength outputted from the light receiving element in the optimal state and the near state and the amount of change in the signal strength outputted from the light receiving element in the optimal state and the far state when the ± first-order diffracted light beams diffracted in the first and second diffraction regions 9 and 10 are detected.

FIG. 14 is a view showing the dependency of signal strength change from the light receiving element in a near state, an optimal state, and a far state. Specifically, FIG. 14 shows the dependency of signal strength change from the light receiving element with respect to the distance between the objective lens and the recording layer of the two-layer optical disk when a change is made from the near state to the far state through the optimal state. In changes of the near state and the far state which should show the same difference with respect to the optimal state, the signal strength in the middle state of the near state and the far state and the signal strength in the optimal state deviate from each other, and a so-called offset state occurs. This is because the light receiving element in the near state detects only a spot with a shape close to the trapezoid while the light receiving element in the far state detects a semicircular spot, and a difference between the detected light intensities occurs accordingly.

Therefore, there is a problem that asymmetry occurs in change of focus error signal. Moreover, in case where asymmetry in change of focus error signal occurs, a margin of focusing servo in either the near state or the far state is reduced, so that focusing servo may easily fail when disturbances such as vibration occur.

### SUMMARY OF THE INVENTION

It is an object of the invention to provide an optical pickup device capable of performing stable focusing servo and an optical disk device having the optical pickup device mounted therein.

The invention provides an optical pickup device comprising:

a light source that emits a light beam toward a recording layer of an optical disk;

an objective lens that condenses the light beam emitted from the light source onto the recording layer of the optical disk;

a light receiving element having a plurality of light receiving regions where a returning light beam after being emitted from the light source and reflected on the recording layer of the optical disk is received, each of the light receiving region carrying out output corresponding to the received light intensity and light receiving regions for focusing which are used for focusing servo being formed as part of the plurality of light receiving regions; and

a diffraction element having a plurality of diffraction regions formed by being divided by a division line, each of the diffraction regions diffracting at least part of returning light beams toward the corresponding light receiving region among the plurality of light receiving regions and diffraction regions for focusing which diffract at least part of the returning light beams toward the light receiving regions for focusing being formed as part of the plurality of diffraction regions,

part of a division line which defines the diffraction region for focusing being formed in a shape which is convex from an outer side toward an inner side with respect to a center of an incidence range on the diffraction element where a returning light beam enters, and

the part of the division line formed in a shape which is convex from the outer side toward the inner side dividing the incidence range on the diffraction element where a returning light beam enters, regardless of whether or not there is a focus error.

According to the invention, the light receiving regions for focusing are formed as part of the plurality of light receiving regions in the light receiving element. In the diffraction element, the diffraction regions for focusing are formed as part of the plurality of diffraction regions. The part of the division line which defines the diffraction region for focusing is formed in a shape which is convex from the outer side toward the inner side with respect to the center of the incidence range on the diffraction element where a returning light beam enters. The part of the division line formed in the shape which is convex from the outer side toward the inner side divides the incidence range on the diffraction element where a returning light beam enters, regardless of whether or not there is a focus error.

Accordingly, the diffraction region for focusing can be formed in a notched shape by the convex part of the division line. In addition, the shape of the notched portion of the diffraction region for focusing can be made as a shape which tapers from the outer side toward the inner side. When the distance from the objective lens to the recording layer of the optical disk changes in a range where focusing servo is performed, the incidence range on the diffraction element expands or contracts. Since the diffraction region for focusing is formed in a notched shape by the part of the division line, the shape of a section perpendicular to the propagating direction of light diffracted in the diffraction region for focusing can be made as a notched shape even if the incidence range on the diffraction element expands or contracts.

Accordingly, it is possible to suppress the situation where the ratio of the light intensity of light beam, which enters the light receiving region for focusing, to the light intensity of all light beams, which enter the diffraction region, changes with the expansion or contraction of the incidence range on the diffraction element, compared with the related art. Therefore, the light intensity of light beam used for focusing servo when the incidence range on the diffraction element expands and the light intensity of light beam used for focusing servo when the incidence range on the diffraction element contracts can be made equal.

As a result, it is possible to suppress the situation where a change of a focus error signal when the distance between the objective lens and the optical disk increases and decreases from the optimal value as a reference value becomes asymmetrical with respect to the optimal value. In this case, it is possible to suppress the situation where the focusing servo easily fails due to the asymmetry of the change of the focus error signal. Accordingly, stable focusing servo can be performed.

Moreover, in the invention, it is preferable that the part of the division line includes an orthogonal line segment perpendicular to a radius which is predetermined with respect to a center of the incidence range, at a predetermined intersection and an inclined line segment that is connected with the orthogonal line segment in a direction becoming distant from the center of the incidence range and that forms a part of a straight line, which crosses a straight line including the predetermined radius, at a side closer to the center of the incidence range than the predetermined intersection is.

According to the invention, the part of the division line includes the orthogonal line segment and the inclined line segment. The orthogonal line segment is perpendicular to the predetermined radius with respect to the center of the incidence range, at the predetermined intersection. The inclined line segment is a line segment which is connected with the orthogonal line segment in a direction becoming distant from the center of the incidence range. In addition, the inclined line segment forms a part of a straight line, which crosses the straight line including the predetermined radius, at the side closer to the center of the incidence range than the predetermined intersection is.

Accordingly, the ratio of the light intensity of light beam entering the diffraction region for focusing to the total light intensity of light beam entering the diffraction element can be made equal in both the case where the incidence range on the diffraction element expands and the case where the incidence range on the diffraction element contracts. Assuming that a portion, which is defined by the part of the division line formed in the convex shape, of the diffraction region adjacent to the diffraction region for focusing is an “adjacent region”, the adjacent region has a shape which becomes wide from the center of the incidence range toward the outer side since the inclined line segment is inclined with respect to the predetermined radius. Accordingly, if the incidence range on the diffraction element expands, the area of a portion where the incidence range and the diffraction region for focusing overlap each other increases, and the area of a portion where the incidence range and the adjacent region overlap each other also increases. As a result, it is possible to suppress the situation where the ratio of the light intensity of light beam, which is used for focusing servo, to the light intensity of all returning light beams changes with an increase or decrease in the area of the incidence range.

Moreover, in the invention, it is preferable that the part of the division line is formed in a shape symmetrical with respect to the straight line including the predetermined radius.

According to the invention, the part of the division line is formed in the shape symmetrical with respect to the straight line including the predetermined radius. Accordingly, in both the case where the incidence range on the diffraction element expands and the case where the incidence range on the diffraction element contracts, the ratio of the light intensity of light beam entering the diffraction region for focusing to the total light intensity of light beam entering the diffraction element can be similarly controlled at both sides of the straight line including the predetermined radius. As a result, in both the case where the incidence range on the diffraction element expands and the case where the incidence range on the diffraction element contracts, the light intensity of light beam used for focusing servo can be easily set.

Moreover, in the invention, it is preferable that the diffraction region for focusing includes two diffraction regions, and

the two diffraction regions are adjacent to each other with a diameter division line, which is perpendicular to the predetermined radius at the center of the incidence range, interposed therebetween.

According to the invention, the diffraction region for focusing includes two diffraction regions, and the two diffraction regions are adjacent to each other with the diameter division line interposed therebetween. The diameter division line is perpendicular to the predetermined radius at the center of the incidence range. Accordingly, the diffraction regions located at both sides of the diameter division line can be used for focusing servo. As a result, the focusing servo can be performed using the double knife edge method.

Moreover, in the invention, it is preferable that the part of the division line is formed in a shape symmetrical with respect to a straight line including the predetermined radius,

the diffraction region for focusing is formed in a shape symmetrical with respect to a straight line including the diameter division line, and

an end of the inclined line segment on a side far from the center of the incidence range is connected with a parallel line segment which is parallel to the diameter division line, and

a value obtained by dividing Da by DH is set to a value which is larger than 0.25 and smaller than 0.35, in which DH denotes a diameter of the incidence range on the diffraction element in a case of focusing on a recording surface of the optical disk, and Da denotes a distance between the center of the incidence range and a straight line including the parallel line segment.

According to the invention, the part of the division line is formed in a shape symmetrical with respect to the straight line including the predetermined radius, and the diffraction region for focusing is formed in a shape symmetrical with respect to the straight line including the diameter division line. The end of the inclined line segment on the side far from the center of the incidence range is connected with the parallel line segment which is parallel to the diameter division line. The value obtained by dividing Da by DH is set to the value which is larger than 0.25 and smaller than 0.35, in which DH denotes a diameter of the incidence range on the diffraction element in a case of focusing on a recoding surface of the optical disk and Da denotes a distance between the center of the incidence range and the straight line including the parallel line segment.

Accordingly, the light intensity of light beam used for focusing servo can be sufficiently ensured, and the ratio of the light intensity in the diffraction region for focusing to the light intensity in the entire incidence range can be easily controlled. By setting the value, which is obtained by dividing Da by DH, to the value exceeding 0.25, the light intensity of light beam used for focusing servo can be sufficiently ensured. In addition, by setting the value obtained by dividing Da by DH to the value smaller than 0.35, the adjacent region can be disposed at the position near the center of the incidence range. Since the density of light beams at the position near the center of the incidence range is larger than the density of light beams at the position near the outer edge, it becomes easy to control the ratio of the light intensity in the diffraction region for focusing to the light intensity in the entire incidence range by the increase or decrease in the area where the adjacent region and the incidence range overlap each other. Accordingly, the precision of focusing servo can be sufficiently ensured.

Moreover, in the invention, it is preferable that, Da is set to be larger than Db, and a difference between Da and Db is set to be smaller than 5% of DH, in which Db denotes a distance between the center of the incidence range and the predetermined intersection.

According to the invention, Da is set to be larger than Db, and a difference between Da and Db is set to be smaller than 5% of DH, in which Db denotes a distance between the center of the incidence range and the predetermined intersection. As a result, in both the case where the incidence range on the diffraction element expands and the case where the incidence range on the diffraction element contracts, the light intensity of light beam entering the diffraction region for focusing can be sufficiently ensured. Accordingly, it becomes easy to control the ratio of the light intensity in the diffraction region for focusing to the light intensity in the entire incidence range. Thus, it is possible to easily suppress the asymmetry of the change of the focus error signal.

Moreover, in the invention, it is preferable that a light receiving surface which receives at least part of returning light beams is formed in the light receiving region, and

light beams diffracted in the diffraction region for focusing may be convergent light beams condensed such that the area of a section perpendicular to the propagating direction of the middle of light beams after diffraction becomes the minimum at the position deviated from the light receiving surface in a direction perpendicular to the light receiving surface.

According to the invention, a light receiving surface which receives at least part of returning light beams is formed in the light receiving region. Light beams diffracted in the diffraction region for focusing are convergent light beams. The convergent light beams are condensed such that the area of the section perpendicular to the propagating direction of the middle of light beams after diffraction becomes the minimum at the position deviated from the light receiving surface. The position where the area of the section of convergence light beams becomes the minimum deviates from the light receiving surface in the direction perpendicular to the light receiving surface. As a result, when performing the focusing servo using the knife edge method, the light intensities of light beams entering two light receiving regions, in which convergent light beams are received, can be made equal with high precision. In this way, the focusing servo can be performed with high precision.

Moreover, in the invention, it is preferable that the light beams diffracted in the diffraction region for focusing are convergent light beams whose area of the section perpendicular to the propagating direction of the middle of light beams after diffraction becomes a minimum at the side of the diffraction element rather than the light receiving surface, and

the distance between the position, at which the area of the section of light beam after diffraction becomes the minimum, and the light receiving surface may be set to be larger than 50 μm and smaller than 100 μm.

According to the invention, the light beams diffracted in the diffraction region for focusing are convergent light beams whose area of the section perpendicular to the propagating direction of the middle of light beams after diffraction becomes the minimum at the side of the diffraction element rather than the light receiving surface. The distance between the position, at which the area of the section of light beam after diffraction becomes the minimum, and the light receiving surface is set to be larger than 50 μm and smaller than 100 μm. Accordingly, the focusing servo can be performed with high precision using the knife edge method, and it is possible to suppress the situation where the ratio of the light intensity of light beam, which enters the diffraction region for focusing, to the light intensity of the entire incidence range changes with expansion and contraction of the incidence range on the diffraction element.

Moreover, the invention provides an optical disk device comprising:

the optical pickup device described above;

a rotation driving section that rotates the optical disk; and

a control section that controls the optical pickup device and the rotation driving section.

According to the invention, the optical disk device includes the optical pickup device described above, the rotation driving section, and the control section. The rotation driving section rotates the optical disk, and the control section controls the optical pickup device and the rotation driving section. As a result, it is possible to suppress the situation where a change of a focus error signal becomes asymmetrical with respect to the optimal value even if the distance between the objective lens and the optical disk increases and decreases from the optimal value as a reference value. In this case, it is possible to suppress the situation where the focusing servo easily fails due to the asymmetry of the change of the focus error signal. As a result, stable focusing servo can be performed.

### BRIEF DESCRIPTION OF DRAWINGS

Other and further objects, features, and advantages of the invention will be more explicit from the following detailed description taken with reference to the drawings wherein:

FIG. 1 is a perspective view of an integration unit according to an embodiment of the invention;

FIG. 2 is a block diagram showing the configuration of the optical disk device according to an embodiment of the invention;

FIG. 3 is a block diagram showing the configuration to control driving of the optical pickup device according to an embodiment of the invention;

FIG. 4 is a side view showing the configuration of the optical pickup device;

FIGS. 5A and 5B are a plan view and a side view of the diffraction element according to the embodiment of the invention;

FIGS. 6A and 6B are diagrams showing the difference between an embodiment and a comparative example;

FIG. 7 is a perspective view of the diffraction region, which shows a method of designing the diffraction element according to the embodiment of the invention;

FIG. 8 is a flow chart showing the process in the method of designing the diffraction element according to the embodiment of the invention;

FIGS. 9A and 9B are diagrams showing the change of a focus error signal when performing the design for changing the condensing point position in the embodiment of the invention;

FIG. 10 is a plan view showing the light receiving element according to the embodiment of the invention;

FIG. 11 is a plan view showing a polarization hologram in the related art;

FIG. 12 is a plan view showing a diffraction element and a light receiving element when an objective lens has come close to a two-layer optical disk in the optical pickup device in the related art;

FIG. 13 is a plan view showing a diffraction element and a light receiving element when an objective lens has become distant from a two-layer optical disk in the optical pickup device in the related art; and

FIG. 14 is a view showing the dependency of signal strength change from the light receiving element in the near state, an optimal state, and the far state.

### DETAILED DESCRIPTION

Now referring to the drawings, preferred embodiments of the invention are described below.

The embodiment described below is illustrated to embody the technique related to the invention and is not intended to limit the technical scope of the invention. The technical contents of the invention may be changed in various ways within the technical scope defined in the appended claims. The following explanation also includes an explanation regarding an optical pickup device 20 and an optical disk device 21.

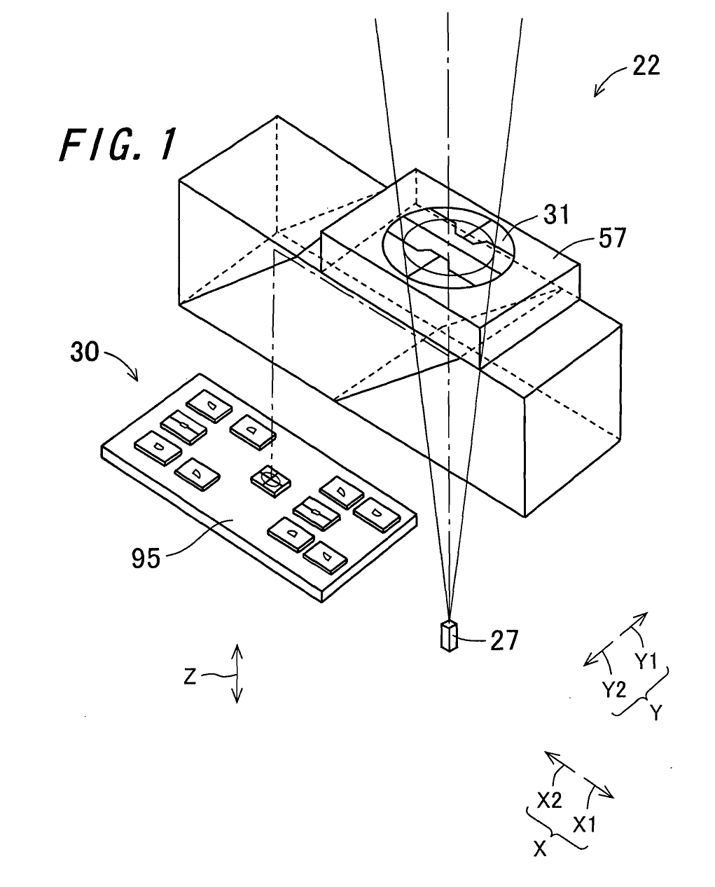

FIG. 1 is a perspective view of an integration unit 22 according to an embodiment of the invention. The optical pickup device 20 is a device which performs at least irradiation of light onto a recording layer 40 of an optical disk. In the present embodiment, the optical pickup device 20 receives reflected light from an optical disk 26 and also performs output based on the reflected light. The optical disk device 21 includes the optical pickup device 20 and performs at least one of reproduction, recording, rewriting, and deletion of the information with respect to the optical disk 26.

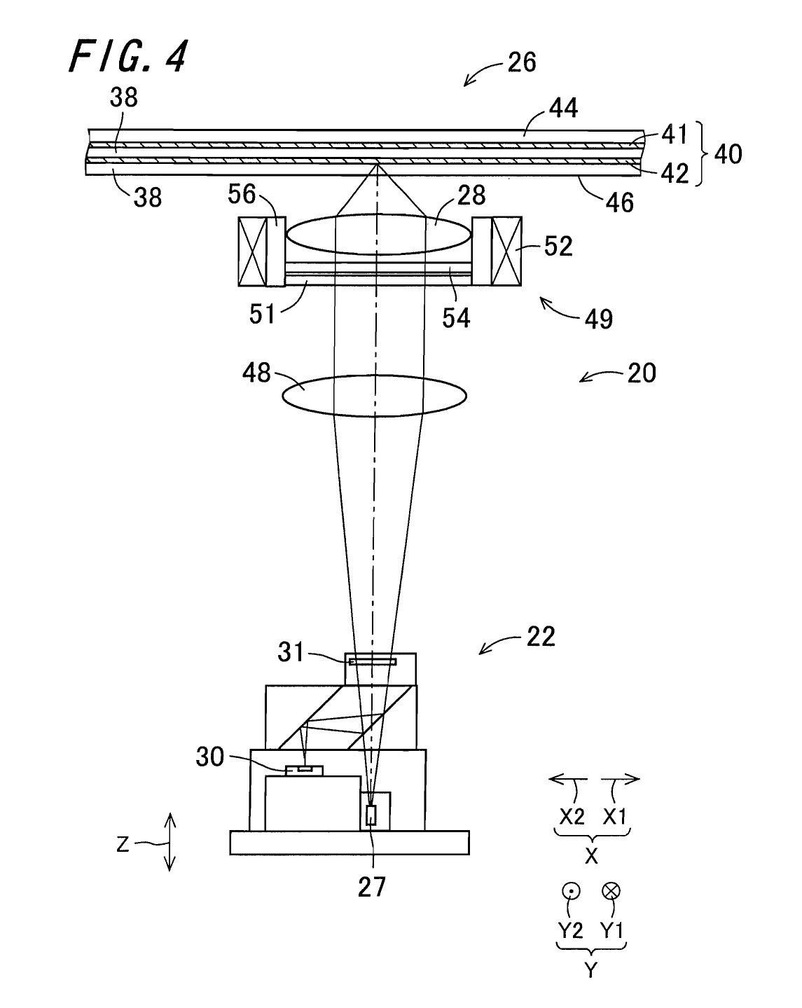

As shown in FIG. 4 to be described later, the optical pickup device 20 includes a light source 27, an objective lens 28, a light receiving element 30, and a diffraction element 31. The light source 27 emits light toward the recording layer 40 of the optical disk. Specifically, the light source 27 emits light which is irradiated onto the recording layer 40 of the optical disk. The optical disk 26 does not necessarily need to be located on the extending line obtained by linearly extending the optical path near the light source 27. The objective lens 28 condenses the light emitted from the light source 27 on the recording layer 40 of the optical disk. The light receiving element 30 includes a plurality of light receiving regions. The plurality of light receiving regions receives a returning light beam after being emitted from the light source 27 and reflected from the recording layer 40 of the optical disk. Each light receiving region performs output corresponding to the intensity of the received light.

In the light receiving element 30, light receiving regions 32 for focusing are formed as part of the plurality of light receiving regions. The light receiving region 32 for focusing is used for focusing servo. The diffraction element 31 has a plurality of diffraction regions formed by division using a division line. Each diffraction region diffracts at least part of the returning light beams toward the corresponding light receiving region among the plurality of light receiving regions. In the diffraction element 31, diffraction regions 33 for focusing are formed as part of the plurality of diffraction regions. The diffraction region 33 for focusing diffracts at least part of the returning light beams toward the light receiving region 32 for focusing.

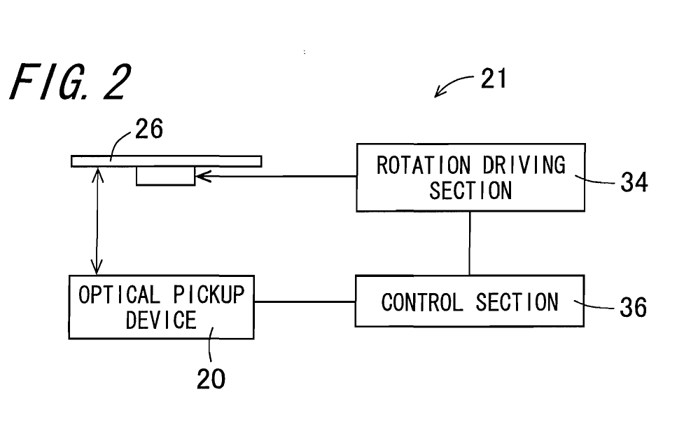

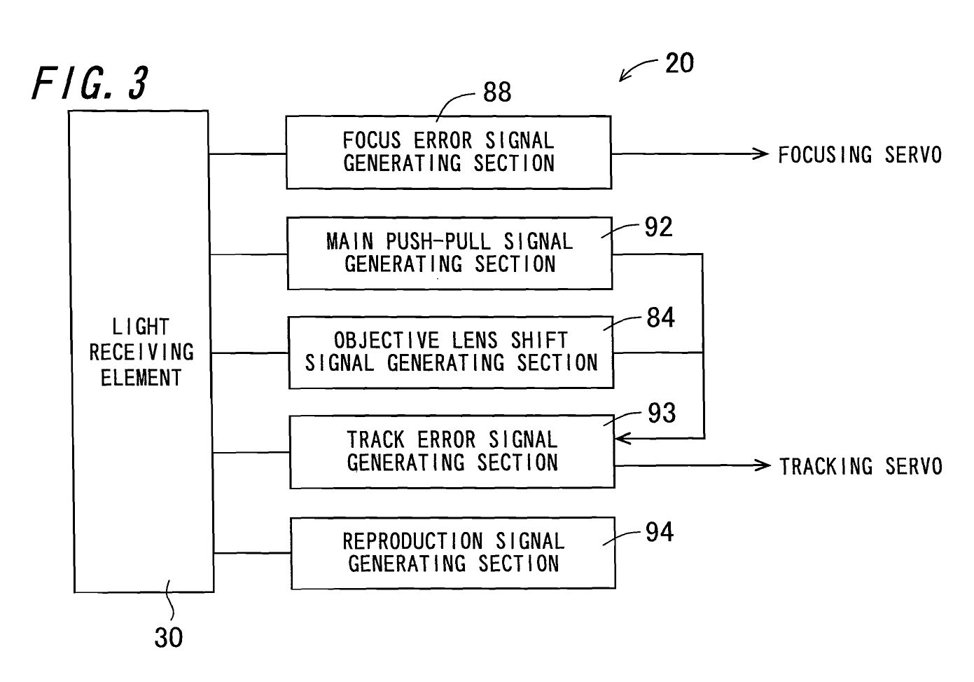

FIG. 2 is a block diagram showing the configuration of the optical disk device 21 according to an embodiment of the invention. FIG. 3 is a block diagram showing the configuration to control driving of the optical pickup device 20 according to an embodiment of the invention. As shown in FIGS. 2 and 3, the optical disk device 21 includes the optical pickup device 20 for recording the information on the optical disk 26, which is an optical information recording medium, or reproducing the information from the optical disk 26; a rotation driving section 34 which rotates the optical disk 26; and a control section 36. The rotation driving section 34 includes a spindle motor. The control section 36 controls each section of the optical disk device 21. Details of the control section 36 will be described later.

The optical disk device 21 also has functions which are not described in detail in this specification. For example, the optical disk device 21 has many functions involving a function required to record the information on the optical disk 26, a function required to reproduce the information from the optical disk 26, and a function required to rewrite the information recorded on the optical disk 26.

FIG. 4 is a side view showing the configuration of the optical pickup device 20. In the present embodiment, the optical disk device 21 which performs recording and reproduction of the information with respect to the optical disk 26, which has the recording layer 40 with a two-layer structure as shown in FIG. 4, will be described as an example. In another embodiment, however, the optical disk 26 may have the recording layer 40 with a three or more layer structure.

The optical disk 26 includes a light transmitting layer 38, a first recording layer 41, a second recording layer 42, and a substrate 44. The first recording layer 41 is formed at the position which is farther from the objective lens 28 and closer to the substrate 44 than the second recording layer 42. A distance between the first and second recording layers 41 and 42 is set to 25 micrometers (simply expressed as “μm”), for example. The thickness of the light transmitting layer 38 from a surface 46 of the optical disk 26 facing the objective lens 28 to the first recording layer 41 is set to 100 μm, for example. The thickness of the light transmitting layer 38 from the surface 46 of the optical disk 26 facing the objective lens 28 to the second recording layer 42 is set to 75 μm, for example.

As shown in FIG. 4, the optical pickup device 20 includes the integration unit 22, a collimating lens 48, and an objective lens unit 49. The integration unit 22 includes the light source 27, the light receiving element 30, the diffraction element 31, and a light branching element. The light branching element defines some optical paths when emitting the light from the light source 27 to the outside of the integration unit 22 and when making the returning light beam from the optical disk 26 entering the light receiving element 30.

The objective lens unit 49 includes a ¼ wavelength plate 51, the objective lens 28, an actuator 52, and an aperture stop 54. The ¼ wavelength plate 51, the objective lens 28, and the aperture stop 54 are fixed to a holder 56 of the actuator 52. When performing a focusing operation and a tracking operation of the objective lens 28 with respect to a target track of the first recording layer 41 or the second recording layer 42 of the optical disk 26, the ¼ wavelength plate 51, the objective lens 28, and the aperture stop 54 are driven by the actuator 52 as an integrated body.

The objective lens 28 condenses laser beams from a semiconductor laser chip, which is the light source 27, onto a target recording layer, which is one of the plurality of recording layers 40 that the optical disk 26 has. The collimating lens 48 is disposed between the integration unit 22, which has a semiconductor laser chip that is the light source 27, and the objective lens 28. In the present embodiment, the collimating lens 48 is the diffraction type collimating lens 48 which is subjected to correction of chromatic aberration together with the objective lens 28.

As shown in FIGS. 1 and 4, the integration unit 22 includes the light source 27, the light receiving element 30, the light branching element, and the diffraction element 31. The diffraction element 31 is a hologram element formed in the shape of a flat plate, and is also called a polarization hologram. In the present embodiment, the light source 27 is realized by a semiconductor laser chip which emits light in a 405 nm band. The light receiving element 30 has a plurality of light receiving regions and is provided between the light source 27 and the polarization hologram. A laser beam emitted from the light source 27 is reflected on the target recording layer of the optical disk 26, and the returning light beam after being diffracted by the diffraction element 31 is received in a plurality of light receiving regions. Details of the light receiving element 30 will be described later.

The light branching element is provided between the light source 27 and the light receiving element 30, and defines the course of incident light from the light source 27 to the optical disk 26 and the course of returning light beam from the optical disk 26 to the light receiving element 30 by making incident light transmitted therethrough or reflected therefrom according to the polarization direction of the incident polarized light.

The diffraction element 31 includes a plurality of diffraction regions. Each diffraction region makes incident light transmitted therethrough or diffracted thereby selectively according to the polarization direction of the incident light. The diffraction element 31 is disposed between the objective lens 28 and the light receiving element 30, more specifically, between the collimating lens 48 and the light receiving element 30 and is supported on a glass substrate 57. The efficiencies of a + first-order diffracted light beam, a zeroth-order diffracted light beam, and a − first-order diffracted light beam are preferably in the range of 1:8:1 to 1:12:1.

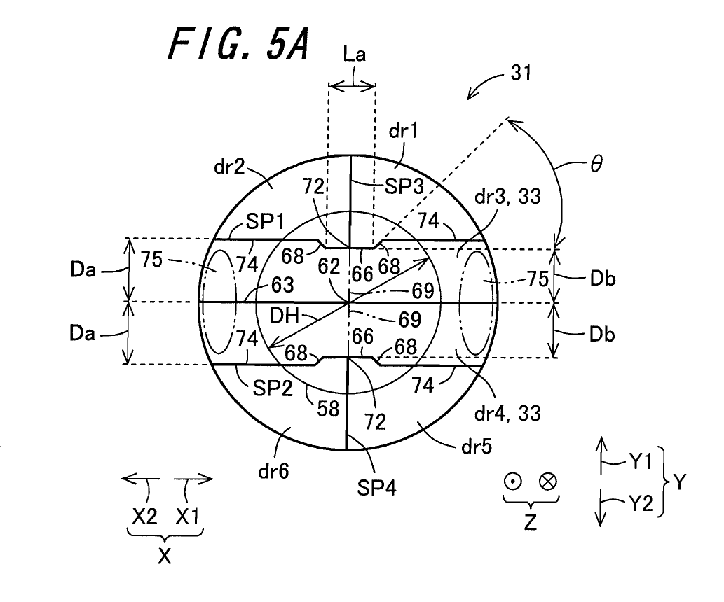

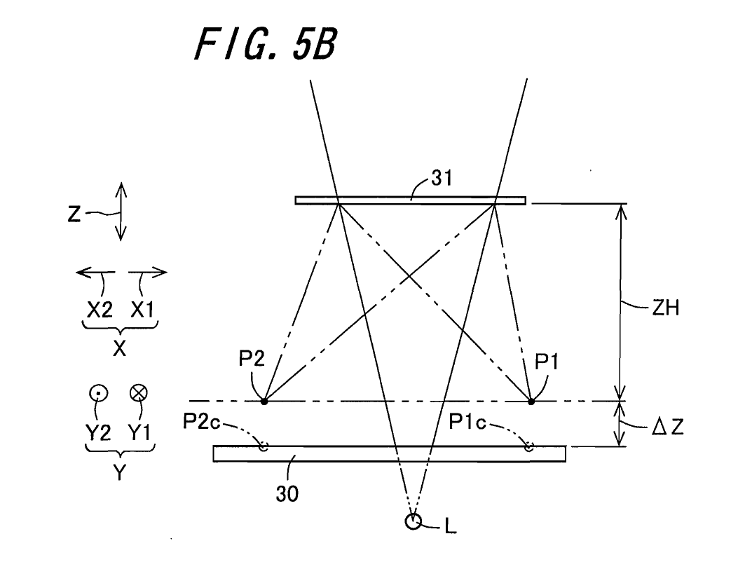

FIGS. 5A and 5B are a plan view and a side view of the diffraction element 31 according to the embodiment of the invention. FIG. 5A shows a diffraction region of the diffraction element 31. In FIG. 5A, a range where a returning light beam enters the diffraction element 31 is also shown together. The range where a returning light beam enters the diffraction element 31 is called an “incidence range” 58. The incidence range 58 on the diffraction element 31 may be expanded or contracted by changing the distance between the target recording layer of the optical disk 26 and the objective lens 28.

The position of a center 62 of the incidence range is not displaced by changing the distance between the target recording layer of the optical disk 26 and the objective lens 28. That is, the position of the center 62 of the incidence range is not displaced according to whether or not there is a focus error. However, when a tracking error occurs, that is, when the positions of a target track and the objective lens 28 deviate from the ideal positions, the central position of the range where a returning light beam enters the diffraction element 31 may be displaced on the diffraction element 31. Hereinafter, the center 62 of the incidence range when the distance between the target recording layer of the optical disk 26 and the objective lens 28 is an ideal distance and the relative positions of the target track and the objective lens 28 are in the ideal positional relationship is simply called “center of the incidence range” 62. In the present embodiment, the diffraction element 31 and the incidence range 58 are formed in circular shapes.

The diffraction element 31 is divided into a plurality of diffraction regions by a plurality of division lines. Since the division line, which passes through the center 62 of the incidence range, among the plurality of division lines is a division line including the diameter of the incidence range 58, the division line is called a “diameter division line” 63. The plurality of division lines formed in the diffraction element 31 include first and second division lines SP1 and SP2, which are located at both sides of the diameter division line 63 with a gap between each of the first and second division lines SP1 and SP2 and the diameter division line 63, and third and fourth division lines SP3 and SP4 which extend in a direction perpendicular to the diameter division line 63. The third division line SP3 is formed at the position which is farther from the center 62 of the incidence range than the first division line SP1, and the fourth division line SP4 is formed at the position which is farther from the center 62 of the incidence range than the second division line SP2.

A direction parallel to the diameter division line 63 corresponds to the radial direction of the optical disk 26. Regarding the diffraction element 31 and the light receiving element 30, a direction corresponding to the radial direction of the optical disk 26 is called a “radial direction” X. On the diffraction element 31 and the light receiving element 30, the direction perpendicular to the radial direction X corresponds to a tangential direction Y at the point, at which light is condensed, on a track of the optical disk 26. This direction is called a “tangential direction” Y. The direction perpendicular to the radial direction X and the tangential direction Y is a direction perpendicular to the light receiving surface of the light receiving element 30 and the diffraction element 31. This direction is called a “vertical direction” Z.

The third and fourth division lines SP3 and SP4 are formed at the positions matching the imaginary straight line which passes through the center 62 of the incidence range and extends in the tangential direction Y. The third division line SP3 is located closer to one tangential direction Y1 than the first division line SP1 is, and an end of the third division line SP3 at the other tangential direction Y2 meets the middle of the first division line SP1 in the radial direction X. The fourth division line SP4 is located closer to the other tangential direction Y2 than the second division line SP2 is, and an end of the fourth division line SP4 at the one tangential direction Y1 meets the middle of the second division line SP2 in the radial direction X. The diffraction element 31 is divided into six diffraction regions by the first to fourth division lines SP1, SP2, SP3, and SP4 and the diameter division line 63.

The diffraction region, which is located closer to the one tangential direction Y1 than the first division line SP1 is and which is located closer to one radial direction X1 than the third division line SP3 is, is assumed to be a first diffraction region dr1. The diffraction region, which is located closer to the one tangential direction Y1 than the first division line SP1 is and which is located closer to the other radial direction X2 than the third division line SP3 is, is assumed to be a second diffraction region dr2. The diffraction region, which is located closer to the one tangential direction Y1 than the diameter division line 63 is and which is located closer to the other tangential direction Y2 than the first division line SP1 is, is assumed to be a third diffraction region dr3. The diffraction region, which is located closer to the other tangential direction Y2 than the diameter division line 63 is and which is located closer to the one tangential direction Y1 than the second division line SP2 is, is assumed to be a fourth diffraction region dr4. The diffraction region, which is located closer to the other tangential direction Y2 than the second division line SP2 is and which is located closer to the one radial direction X1 than the fourth division line SP4 is, is assumed to be a fifth diffraction region dr5. The diffraction region, which is located closer to the other tangential direction Y2 than the second division line SP2 is and which is located closer to the other radial direction X2 than the fourth division line SP4 is, is assumed to be a sixth diffraction region dr6.

A main push-pull signal is generated with light transmitted through the diffraction element 31 among the six diffraction regions, and an objective lens shift signal is generated by calculating the light diffracted in four diffraction regions of the first, second, fifth, and sixth diffraction regions dr1, dr2, dr5, and dr6. In addition, a focus error signal is generated using the third and fourth diffraction regions dr3 and dr4. In this specification, a term “transmitted” is used for both the zeroth-order diffracted light beam, which enters the diffraction region and is then emitted from the diffraction region without the direction of the course being changed by the diffraction, and the ± first-order diffracted light beams, which enter the diffraction region and are then emitted from the diffraction region after the direction of the course is changed by the diffraction.

The first to sixth diffraction regions dr1, dr2, dr3, dr4, dr5, and dr6 diffract returning light beams from the optical disk 26 in different directions. Of light beams diffracted from each region, the ± first-order diffracted light beams are also guided onto the light receiving element 30 and are used for signal generation. As a result, a total of thirteen beams including the zeroth-order diffracted light beam are generated in a polarization hologram. That is, the diffraction element 31 is divided into a plurality of regions for generating a plurality of kinds of signals. As shown in FIG. 5A, division lines of a polarization hologram are formed by five straight lines.

A part of a division line which defines the diffraction region 33 for focusing is formed in a shape which is convex toward the center 62 of the incidence range on the diffraction element 31 where a returning light beam enters. The part of the division line formed in the shape which is convex toward the center 62 of the incidence range divides the incidence range 58 on the diffraction element 31 where a returning light beam enters, regardless of whether or not there is a focus error.

If only the diffraction region 33 for focusing is imaginarily taken out, a notch is formed in the diffraction region 33 for focusing from the outer side of the radial direction of the spot of the incidence range 58 toward the inner side of the radial direction, and the distance between the ends of diffraction regions which face the peripheral direction with the notch interposed therebetween decreases toward the inner side of the radial direction.

The part of the division line includes an orthogonal line segment 66 and an inclined line segment 68. The orthogonal line segment 66 is perpendicular to a predetermined radius 69 for the center 62 of the incidence range, at a predetermined intersection 72. The inclined line segment 68 is a line segment which is connected with the orthogonal line segment 66 in a direction becoming distant from the center 62 of the incidence range. In addition, the inclined line segment 68 forms a part of a straight line, which crosses a straight line including the predetermined radius 69 at the side closer to the center 62 of the incidence range than the predetermined intersection 72 is.

The part of the division line is formed in a shape symmetrical with respect to a straight line including the predetermined radius 69.

The diffraction region 33 for focusing includes two diffraction regions. The two diffraction regions are adjacent to each other with the diameter division line 63 interposed therebetween. The diameter division line 63 is perpendicular to the predetermined radius 69 at the center 62 of the incidence range.

The diffraction region 33 for focusing is formed in a shape symmetrical with respect to a straight line including the diameter division line 63. An end of each inclined line segment 68 on the side far from the center 62 of the incidence range is connected with a parallel line segment 74 which is parallel to the diameter division line 63. The value obtained by dividing Da by DH is set to a value which is larger than 0.25 and smaller than 0.35, in which DH denotes a diameter of the incidence range 58 on the diffraction element 31 when there is no focus error, that is, in a case of focusing on a recording surface of the optical disk, and Da denotes a distance between the center 62 of the incidence range and the parallel line segment 74.

Da is set to be larger than Db, and the difference between Da and Db is set to be smaller than 5% of DH, in which Db denotes a distance between the center 62 of the incidence range and the predetermined intersection 72.

Regarding the distance Db between the center 62 of the incidence range and the intersection 72, the value obtained by dividing Db by DH is set to a value which is larger than 0.25 and smaller than 0.3.

The first division line SP1 and the third division line SP3 meet at the predetermined intersection 72 on the first division line SP1. The second division line SP2 and the fourth division line SP4 meet at the predetermined intersection 72 on the second division line SP2. Straight line segments included in the first and second division lines SP1 and SP2 are parallel to the diameter division line 63. The two parallel line segments 74, which are included in the first division line SP1 and which are located closer to the one radial direction X1 and the other radial direction X2 than the orthogonal line segment 66 included in the first division line SP1, are also parallel to the diameter division line 63. The two parallel line segments 74, which are included in the second division line SP2 and which are located closer to the one radial direction X1 and the other radial direction X2 than the orthogonal line segment 66 included in the second division line SP2, are also parallel to the diameter division line 63.

In this specification, “parallel” is assumed to include “approximately parallel”. The orthogonal line segments 66 included in the first and second division lines SP1 and SP2 are formed to extend in the radial direction X. The length of each orthogonal line segment 66 is set to La. As shown in FIG. 5A, there are two predetermined intersections 72, which include an intersection between the first and third division lines SP1 and SP3 and an intersection between the second and fourth division lines SP2 and SP4. The predetermined radius 69 is a line segment connecting the center of the incidence region with each predetermined intersection 72. In FIG. 5A, two predetermined radii 69 are shown.

It is preferable that θ is set to be larger than 0° and smaller than 45°, in which θ denotes the angle formed between the direction of the inclined line segment 68 and the radial direction X. The relationship between Da and DH satisfies expression (1).

0.25<(Da/DH)<0.35 (1)

By making the relationship between Da and DH satisfy expression (1), an influence of an interference pattern, which is included in the returning light beam from the optical disk 26, on the objective lens shift signal can be reduced to the minimum.

Among the returning light beams, light beams including interference patterns enter the vicinity of the end of the one radial direction X1 and the other radial direction X2 in the incidence range 58 on the diffraction element 31. Assuming that this region is an “interference pattern region” 75 on the diffraction element 31, each interference pattern region 75 is formed to be long in the tangential direction Y. If an imaginary straight line is drawn from the center 62 of the incidence range toward the end of each interference pattern region 75 in the one tangential direction Y1 and the other tangential direction Y2, the imaginary straight line, which is interposed between the interference pattern regions 75, and each interference pattern region 75 form an angle of about 45°. Since the light intensity of light beam after being diffracted in the interference pattern region 75 in the diffraction element 31 may be uneven, it is preferable to avoid the situation where adjacent regions used for adjustment of the light intensity and a convex division line are disposed in the interference pattern region 75.

A part of a division line, which defines the diffraction region 33 for focusing and which is formed in a shape that is convex toward the center 62 of the incidence range on the diffraction element where a returning light beam enters, includes the orthogonal line segment 66 and the inclined line segment 68 and also includes a part of the parallel line segment 74 adjacent to the inclined line segment 68. Accordingly, the diffraction region 33 for focusing is formed in a notched shape by the part of the division line which is convex. The shape of the notched portion of the diffraction region 33 for focusing is a shape which tapers from the outer side toward the inner side.

When the distance from the objective lens 28 to the recording layer 40 of the optical disk changes in a range where focusing servo is performed, the incidence range 58 on the diffraction element 31 expands or contracts. Since the diffraction region 33 for focusing is formed in a notched shape by the part of the division line, the shape of a section perpendicular to the propagating direction of light diffracted in the diffraction region 33 for focusing becomes a notched shape even if the incidence range 58 on the diffraction element 31 expands or contracts.

In the case where the section of light beam entering the light receiving region 32 for focusing when the distance between the recording layer 40 of the optical disk and the objective lens 28 decreases becomes a shape close to a trapezoid and the section of light beam entering the light receiving region 32 for focusing when the distance between the recording layer 40 of the optical disk and the objective lens 28 increases becomes a semicircle like the related art, the ratio of the light intensity of light beam, which enters the light receiving region 32 for focusing, to the light intensity of all light beams, which enter the diffraction region changes with a change in the distance between the recording layer 40 of the optical disk and the objective lens 28.

The ratio of the light intensity of light beam, which enters the light receiving region 32 for focusing, to the light intensity of all light beams, which enter the diffraction region, is called a “light intensity ratio”, and the change in the light intensity ratio according to the change in the distance between the recording layer 40 of the optical disk and the objective lens 28 is called a “light intensity ratio change”. The case where the distance between the recording layer 40 of the optical disk and the objective lens 28 is an optimal value is called an “ideal state”, the state where the distance between the recording layer 40 of the optical disk and the objective lens 28 is shorter than that in the ideal state is called a “near state”, and the state where the distance between the recording layer 40 of the optical disk and the objective lens 28 is longer than that in the ideal state is called a “far state”. If the sectional shape of light beam entering the light receiving region for focusing changes between the near state and the far state like the related art, the light intensity ratio changes.

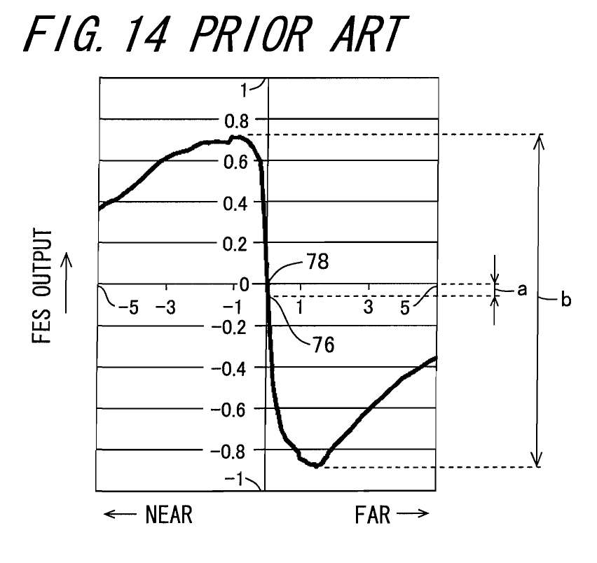

An output from the light receiving region 32 for focusing changes with a change in the distance between the recording layer 40 of the optical disk and the objective lens 28, and the shift amount of the objective lens 28 can be calculated by the change in the output from the light receiving region 32 for focusing. Accordingly, it is preferable that the change ratio of the output change from the light receiving region 32 for focusing to the change in the distance between the recording layer 40 of the optical disk and the objective lens 28 is equal between the near state and the far state. However, if the light intensity ratio changes, the change ratio is not equal between the near state and the far state. Accordingly, so-called offset occurs as shown in FIG. 14.

In the present embodiment, however, the sectional shape of light beam entering the light receiving region for focusing is almost the same between the near state and the far state. Therefore, the light intensity of light beam used for focusing servo when the incidence range 58 on the diffraction element 31 expands and the light intensity of light beam used for servo when the incidence range 58 on the diffraction element 31 contracts become equal. As a result, it is possible to suppress the situation where a change of a focus error signal, when the distance between the objective lens 28 and the optical disk 26 increases and decreases from the optimal value as a reference value, becomes asymmetrical with respect to the optimal value.

Especially by setting the value, which is obtained by dividing Da by DH, to the value exceeding 0.25 in the relationship between Da and DH, the sufficiently large light intensity of light beam used for focusing servo can be ensured. In addition, by setting the value obtained by dividing Da by DH to the value smaller than 0.35, the adjacent region can be disposed at the position near the center 62 of the incidence range. Since the density of light beams at the position near the center of the incidence range 58 is larger than the density of light beams at the position near the outer edge, it becomes easy to control the light intensity ratio by disposing an adjacent region at the position near the center 62 of the incidence range.

In addition, the relationship between Da, Db, and DH is assumed to satisfy expression (2).

0<(Da−Db)<(0.05×DH) (2)

By making the relationship between Da, Db, and DH satisfy expression (2), the ideal relationship between Db and DH is also derived from expressions (1) and (2).

Since Db<Da is satisfied from expression (1), expression (3) is obtained by changing expression (2).

(Db/DH)<(Da/DH)<(Db/DH+0.05) (3)

Here, the relationship between Db and DH is assumed to satisfy expression (4).

0.25<(Db/DH)<0.3 (4)

Expression (5) is derived from expressions (3) and (4).

0.25<(Db/DH)<(Da/DH)<(Db/DH+0.05)<0.35 (5)

Accordingly, the range of (Da/DH) defined by expression (1) is equal to the range of (Da/DH) allowed when expressions (3) and (4) are satisfied. Accordingly, it is preferable that the relationship between Db and DH satisfies expression (4)

That is, Db satisfies the relationship of 0.25<(Db/DH)<0.3. By setting Db to this range, offset occurring in the light intensity ratio when the objective lens 28 shifts can be made so small as to be negligible.

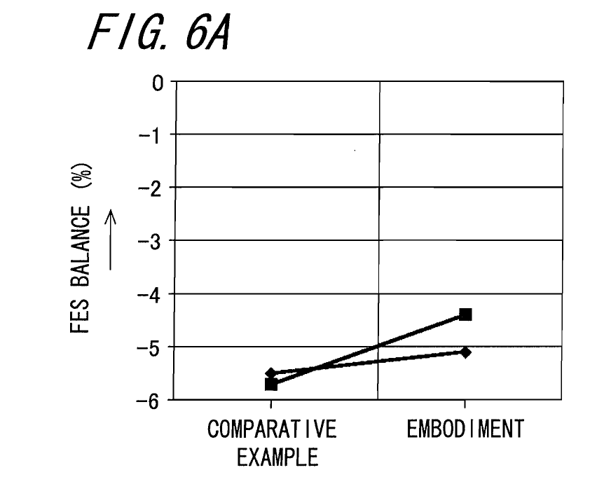

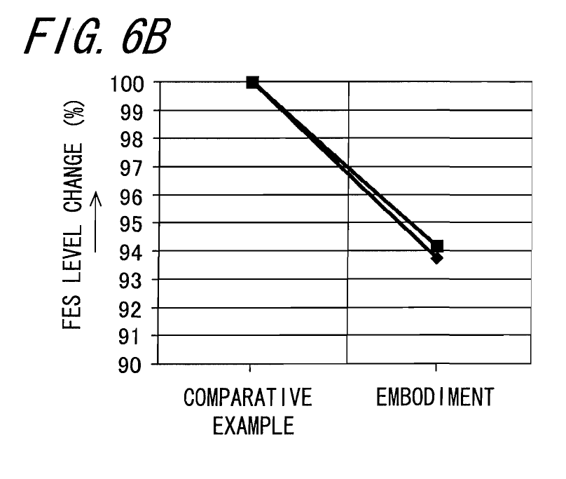

FIGS. 6A and 6B are diagrams showing the difference between an embodiment and a comparative example. The case where each of the first and second division lines SP1 and SP2 is formed as a line segment parallel to the diameter division line 63 is a comparative example. In FIG. 6A, the offset amount in the comparative example is shown at the left side and the offset amount in the present embodiment is shown at the right side. FIG. 6B shows the difference between the present embodiment and the comparative example regarding the light intensity of light beam entering the light receiving region 32 for focusing.

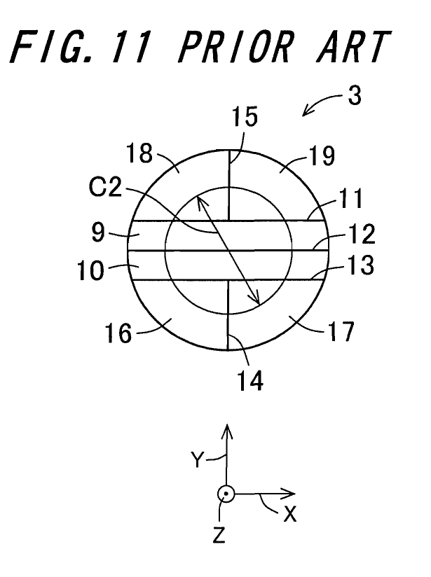

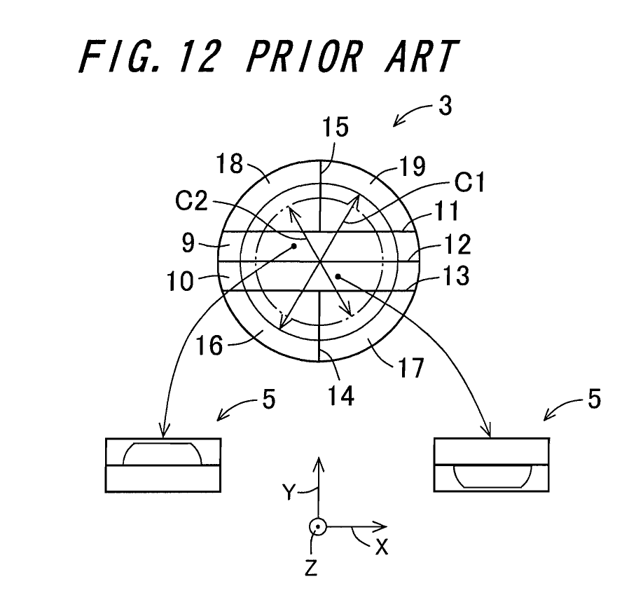

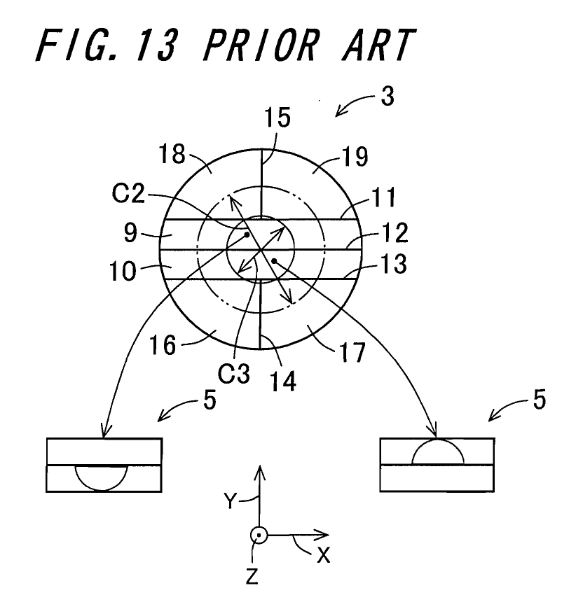

In the comparative example where each diffraction region on the diffraction element 31 is formed in the shape shown in FIGS. 11 to 13, offset exceeding 5% occurs as shown in FIGS. 6A and 14. In FIGS. 6A and 14, the difference between maximum and minimum values of the output from the light receiving region 32 for focusing when the distance between the recording layer 40 of the optical disk and the objective lens 28 changes is expressed as 100%. The value shown on the vertical axis in FIG. 6A indicates a difference between the output from the light receiving region 32 for focusing in the ideal state and the median value of maximum and minimum values of the output from the light receiving region 32 for focusing. The median value of the maximum and minimum values may be called a “median value of a signal range for focusing” 76.

As shown in FIG. 6A, in the comparative example where the first and second division lines SP1 and SP2 and the diameter division line 63 are formed in the shape of a straight line, the asymmetry of a focus error signal exceeding 5% occurs. On the other hand, according to the present embodiment, an improvement of 0.5 to 1% is possible compared with the difference rate in the comparative example. As shown in FIG. 6B, the area of each of the third and fourth diffraction regions dr3 and dr4 decreases by about 5% compared with that in the comparative example. Accordingly, the focus error signal amplitude is also reduced by about 5%. This amount of change in the focus error signal amplitude is not a difference to cause a problem in the quality of a signal from the light receiving region 32 for focusing.

The length La of the orthogonal line segment 66 is set such that it does not overlap the interference pattern region 75 included in the returning light beam from an optical information recording medium on the diffraction element 31. For example, by making the above-described conditions of Da and Db satisfied and setting La<0.27DH to be satisfied, the interference pattern region 75 included in the returning light beam from the optical disk 26 can be avoided even if the objective lens 28 shifts. As a result, it becomes possible to correct the asymmetry of a focus error signal without affecting the shift signal for the objective lens 28.

The angle formed between the inclined line segment 68 and a straight line parallel to the diameter division line 63 is set to an angle which is larger than 0° and smaller than 45°. In this range, it is preferable that the angle is set to an angle near 45°. In this case, a change in the light intensity ratio when the incidence range 58 on the diffraction element expands or contracts can be set to a value suitable for suppressing the occurrence of offset.

A light receiving surface which receives at least part of returning light beams is formed in each light receiving region. Light beams diffracted in the diffraction region 33 for focusing are convergent light beams. The convergent light beams are condensed such that the area of a section perpendicular to the propagating direction of the middle of light beams after diffraction becomes the minimum at the position deviated from the light receiving surface. The position where the area of the section of convergent light beams becomes the minimum deviates from the light receiving surface in a direction perpendicular to the light receiving surface, that is, in the vertical direction Z.

The light beams diffracted in the diffraction region 33 for focusing are convergent light beams whose area of the section perpendicular to the propagating direction of the middle of light beams after diffraction becomes the minimum at the side of the diffraction element 31 rather than the light receiving surface. The distance between the position, at which the area of the section of light beam after diffraction becomes the minimum, and the light receiving surface is set to be larger than 50 μm and smaller than 100 μm. The optical disk device 21 includes the optical pickup device 20 and the rotation driving section 34.

Moreover, in the diffraction element 31 of the present embodiment, in order to improve the asymmetry of a change of a focus error signal, the positions of the condensing points of ± first-order diffracted light beams after being diffracted in the third and fourth diffraction regions dr3 and dr4 are set as positions deviated from the light receiving surface of the light receiving region 32 for focusing, as shown in FIG. 5B. The ± first-order diffracted light beams after being diffracted in the third and fourth diffraction regions dr3 and dr4 enter each light receiving region 32 for focusing. In addition, the ± first-order diffracted light beams after being diffracted in the third and fourth diffraction regions dr3 and dr4 are convergent light beam, and these condensing point positions are set as positions deviated by Δz from the light receiving surface to the diffraction element 31 side, respectively.

In this case, it is possible to reduce the offset amount between the focusing point in the ideal state and the zero-crossing point of a focus error signal in the related art shown in FIG. 14. Accordingly, it is not necessary to change the method of focusing servo between the near state and the far state when the zero-crossing point is located in the middle. As a result, it is possible to improve the balance of a signal waveform of the focus error signal and to stabilize the focusing servo itself.

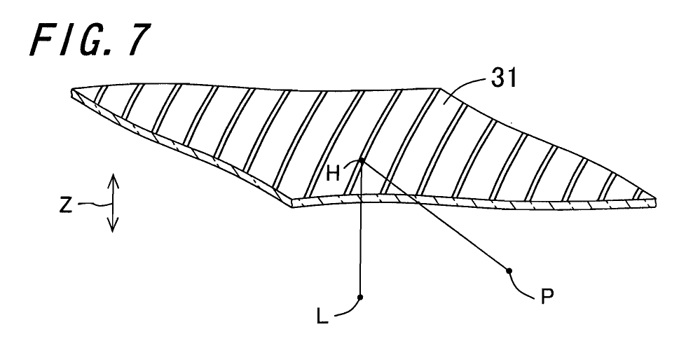

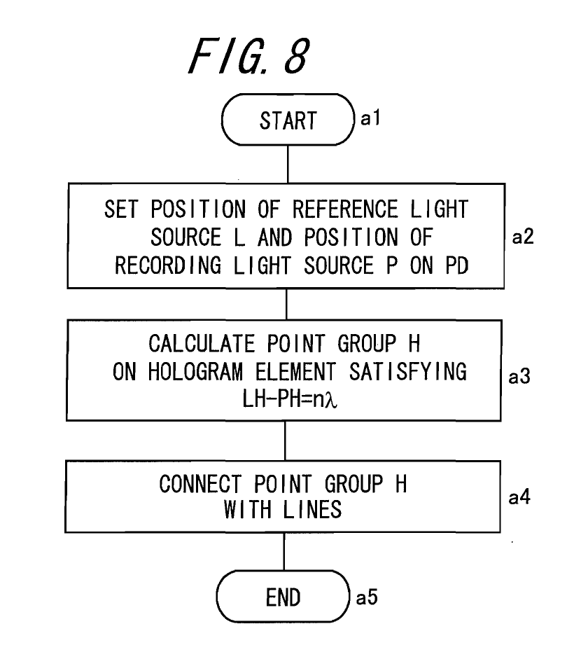

FIG. 7 is a perspective view of the diffraction region, which shows a method of designing the diffraction element 31 according to the embodiment of the invention. FIG. 8 is a flow chart showing the process in the method of designing the diffraction element 31 according to the embodiment of the invention. The pattern in each diffraction region of the diffraction element 31 is an interference fringe on the diffraction region of diverging light from two points of a reference light source L and a condensing point (hereinafter, referred to as a recording light source) P on the light receiving surface. Hereinafter, the condensing point on the light receiving surface is called a “recording light source”.

Starting the procedure from Step a1, at Step a2, positions of the reference light source L and the recording light source P on the light receiving surface are set. The reference light source L is set at the position as a reference when designing the diffraction element 31. The distance between the reference light source L and the diffraction element 31 is set such that the spot diameter of light beam entering a hologram is as large as possible. The larger the spot diameter on the diffraction element 31 is set, the more the positional deviation of each diffraction region with respect to the position of the spot of light beam entering the diffraction element is allowed.

Each group of the pattern formed in a diffraction region is formed as a locus of the point at which the optical path difference between the optical path length from the reference light source L and the optical path length from the recording light source becomes an integral multiple of the light source wavelength used in the optical pickup device 20. Assuming that the point on the diffraction region which satisfies the condition is a attention point H, the relationship of LH−PH=nλ is satisfied among the distance LH from the reference light source L to the attention point H, the distance PH from the recording light source P to the attention point H, and the light source wavelength λ when the refractive index is set to 1. n is an integer. In this way, at Step a3, a point group H on the hologram element lead by LH−PH=nλ is calculated. At Step a4, the point group H is connected with lines, and then, at Step a5, the procedure is ended.

In the related art, the condensing point position of convergent light beam after being diffracted in the diffraction region 33 for focusing is set as a position on the light receiving surface of the light receiving region 32 for focusing. Regarding the ± first-order diffracted light beams, assuming that P1 and P2 denote the condensing point positions in the present embodiment and P1c and P2c denote the condensing point positions in the related art, P1 and P2 are set at the positions deviated by Δz from P1c and P2c toward the diffraction element 31 side. Accordingly, light beams after being diffracted in the third and fourth diffraction regions dr3 and dr4 are not condensed on the light receiving surface of the light receiving element for focusing and enter the light receiving surface of the light receiving element for focusing in a state where the section of light beams has slightly increased. In the present embodiment, the distance in the vertical direction Z from the condensing point positions P1 and P2 to the light receiving surface is called a “condensing point shift amount”.

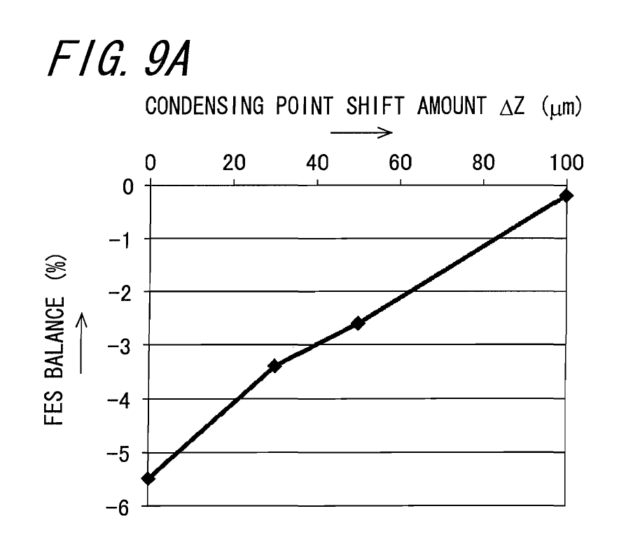

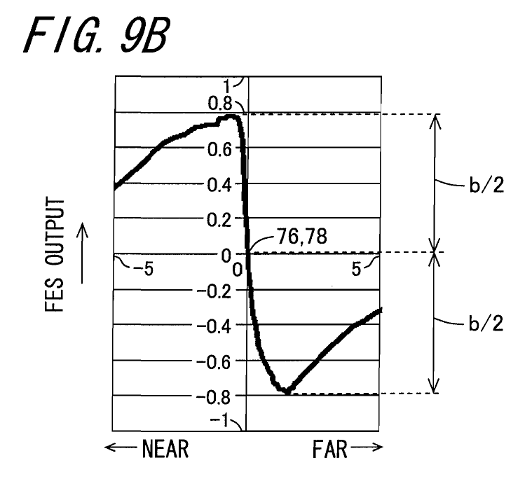

If a design change in the position of a condensing point is made only in the vertical direction Z using as a reference state a state where the light beams after being diffracted in the third and fourth diffraction regions dr3 and dr4 are condensed on the light receiving surface of the light receiving element for focusing, the focus error signal in the ideal state changes to a state deviated from the median value 76 of the signal range for focusing as shown in FIGS. 9A and 9B, which will be described later. For this reason, design change for angular displacement of the posture of the diffraction element 31 is further performed. This design change is angular displacement of the diffraction element 31 around the straight line extending in the vertical direction Z through the center 62 of the incidence range. As a result, when performing the focusing servo using the knife edge method, the light intensities of light beams entering two light receiving regions, in which convergent light beams are received, can be made equal with high precision.

A signal of a measurement result when measuring a focus error quantitatively in response to the output from the light receiving region 32 for focusing is called a “focus error signal”. When a focus error occurs, the focus error signal is not zero. However, also when the focus error signal is outputted as zero in the ideal state, a signal outputted by the same processing as measurement and output related to the focus error is called a “focus error signal”. In addition, the value of the focus error signal in the ideal state is called an “ideal state signal value” 78.

FIGS. 9A and 9B are diagrams showing the change of a focus error signal when performing the design for changing the condensing point position in the embodiment of the invention. FIG. 9A shows the deviation between the median value 76 of the signal range for focusing and the ideal state signal value 78, and FIG. 9B shows a focus error signal in the near state and the far state when the condensing point shift amount Δz is set to 100 μm.

FIGS. 9A and 9B show the deviation between the median value 76 of the signal range for focusing and the ideal state signal value 78 in a state where the ideal state signal value 78 is set to zero by angular displacement of the diffraction element 31. As shown in FIG. 9A, if the condensing point shift amount Δz is set to 100 μm, the deviation between the median value 76 of the signal range for focusing and the ideal state signal value 78 can be set to almost zero. As shown in FIG. 9B, if the condensing point shift amount is set to 100 μm, the profile of a focus error signal when the objective lens 28 is shifted in the near state and the far state becomes a profile which is symmetrical with respect to the focus error signal in the ideal state.

That is, the deviation between the median value 76 of the signal range for focusing and the ideal state signal value 78, which cannot be set to zero only by designing parts of the division lines defining the third and fourth diffraction regions dr3 and dr4 in a shape which is convex from the outer side toward the inner side, can be set to zero by setting the condensing point shift amount as a significant value. As a result, the asymmetry of the focus error signal can be set to almost zero, as shown in FIG. 9B.

In the present embodiment, when a matter in the optical path is converted as the air, assuming that ZH denotes the length of the optical path between the diffraction region of the diffraction element 31 and the light receiving surface of the light receiving element 30, ZH is set to 5.3 millimeters (hereinafter, simply described “mm”). In this case, ZH is a tolerance of the set length and is set to ±200 μm or preferably to the value near zero.

This is a defined value which is experientially considered to be necessary when a part tolerance and an assembly tolerance are taken into consideration. In this case, it is preferable that the value of Δz is set to a value which is larger than 50 μm and smaller than 100 μm.

If design change for displacing the entire light receiving element 30 in the vertical direction Z is performed in order to make the condensing point positions P1 and P2 of light beams after being diffracted in the diffraction region deviate from the position of the light receiving surface in the vertical direction Z, light receiving regions other than the light receiving region 32 for focusing, for example, a light receiving region used for a tracking servo is also displaced in the vertical direction Z. Accordingly, this is not preferable. On the other hand, in the present embodiment, the condensing point positions P1 and P2 can be set as positions deviated from the light receiving surface only for the light receiving region 32 for focusing, which is related to the focus error signal, by performing design change of a group of a hologram pattern formed in a diffraction region.

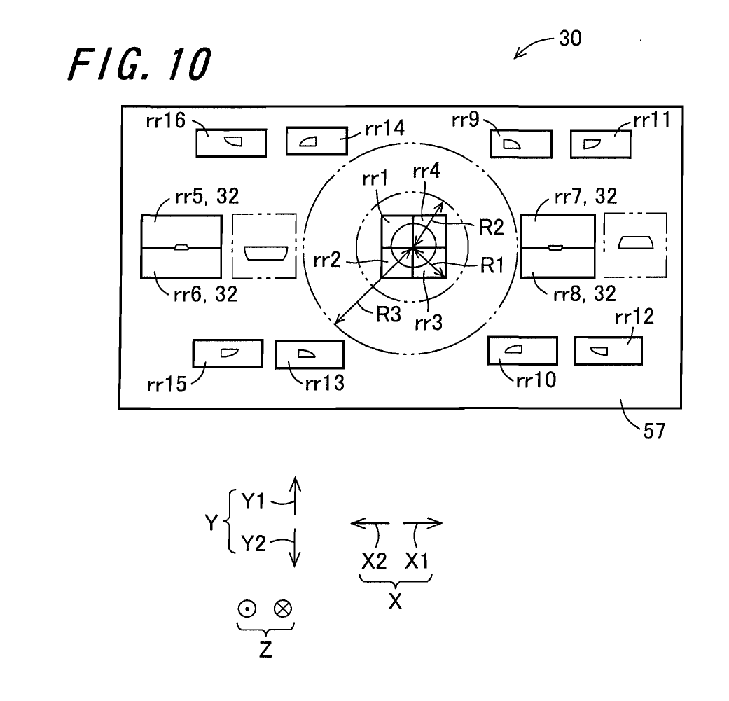

FIG. 10 is a plan view showing the light receiving element 30 according to the embodiment of the invention. As shown in FIG. 10, the light receiving element 30 receives a returning light beam to output a reproduction signal and also outputs a focus error signal and a tracking error signal. The tracking error signal is generated using a main push-pull signal and an objective lens shift signal. The main push-pull signal is generated using first to fourth light receiving regions rr1, rr2, rr3, and rr4 which receive a zeroth-order diffracted light beam after being transmitted through the diffraction region.

The first and second light receiving regions rr1 and rr2 are aligned so as to be adjacent to each other in the tangential direction Y, and the first light receiving region rr1 is disposed closer to the one tangential direction Y1 than the second light receiving region rr2 is. The third and fourth light receiving regions rr3 and rr4 are disposed closer to the one radial direction X1 than the first and second light receiving regions rr1 and rr2 are. The third light receiving region rr3 is disposed adjacent to the second light receiving region rr2, and the fourth light receiving region rr4 is disposed adjacent to the first light receiving region rr1. The third and fourth light receiving regions rr3 and rr4 are aligned so as to be adjacent to each other in the tangential direction Y, and the fourth light receiving region rr4 is disposed closer to the one tangential direction Y1 than the third light receiving region rr3 is. Outputs from the first to fourth light receiving regions rr1, rr2, rr3, and rr4 are assumed to be S1 to S4, respectively. All of the zeroth-order diffracted light beams from the incidence region on the diffraction element 31 are received in any of the first to fourth light receiving regions rr1, rr2, rr3, and rr4.

The focus error signal is generated using fifth to eighth light receiving regions rr5, rr6, rr7, and rr8 which receive ± first-order diffracted light beams diffracted by the diffraction element 31. The fifth to eighth light receiving regions rr5, rr6, rr7, and rr8 are the light receiving region 32 for focusing. The fifth and sixth light receiving regions rr5 and rr6 are disposed closer to the other radial direction X2 than the first to fourth light receiving regions rr1, rr2, rr3, and rr4 are, and are also disposed so as to be separated from the first to fourth light receiving regions rr1, rr2, rr3, and rr4. The fifth and sixth light receiving regions rr5 and rr6 are disposed in a line so as to be adjacent to each other in the tangential direction Y. The fifth light receiving region rr5 is disposed closer to the one tangential direction Y1 than the sixth light receiving region rr6 is.

The seventh and eighth light receiving regions rr7 and rr8 are disposed closer to the one radial direction X1 than the first to fourth light receiving regions rr1, rr2, rr3, and rr4 are, and are also disposed so as to be separated from the first to fourth light receiving regions rr1, rr2, rr3, and rr4. The seventh and eighth light receiving regions rr7 and rr8 are disposed in a line so as to be adjacent to each other in the tangential direction Y. The seventh light receiving region rr7 is disposed closer to the one tangential direction Y1 than the eighth light receiving region rr8 is.

One of the ± first-order diffracted light beams from the third diffraction region dr3 enters the seventh and eighth light receiving regions rr7 and rr8. In the ideal state, they enter the vicinity of the borderline of the seventh and eighth light receiving regions rr7 and rr8. If a focus error occurs, a difference occurs between the outputs from the seventh and eighth light receiving regions rr7 and rr8. One of the ± first-order diffracted light beams from the fourth diffraction region dr4 enters the fifth and sixth light receiving regions rr5 and rr6. In the ideal state, they enter the vicinity of the borderline of the fifth and sixth light receiving regions rr5 and rr6. If a focus error occurs, a difference occurs between the outputs from the fifth and sixth light receiving regions rr5 and rr6.

The objective lens shift signal is generated using ninth to twelfth light receiving regions rr9, rr10, rr11, and rr12 which receive the ± first-order diffracted light beams diffracted by the diffraction element 31. The ninth and eleventh light receiving regions rr9 and rr11 are disposed closer to the one radial direction X1 than the first to fourth light receiving regions rr1, rr2, rr3, and rr4 are, and are also disposed so as to be separated from the first to fourth light receiving regions rr1, rr2, rr3, and rr4. In addition, the ninth and eleventh light receiving regions rr9 and rr11 are disposed closer to the one tangential direction Y1 than the seventh and eighth light receiving regions rr7 and rr8 are, and are also disposed so as to be separated from the seventh and eighth light receiving regions rr7 and rr8. The ninth and eleventh light receiving regions rr9 and rr11 are disposed in a line in the radial direction X so as to be separated from each other. The eleventh light receiving region rr11 is disposed closer to the one radial direction X1 than the ninth light receiving region rr9 is.

The tenth and twelfth light receiving regions rr10 and rr12 are disposed closer to the one radial direction X1 than the first to fourth light receiving regions rr1, rr2, rr3, and rr4 are, and are also disposed so as to be separated from the first to fourth light receiving regions rr1, rr2, rr3, and rr4. In addition, the tenth and twelfth light receiving regions rr10 and rr12 are disposed closer to the other tangential direction Y2 than the seventh and eighth light receiving regions rr7 and rr8 are, and are also disposed so as to be separated from the seventh and eighth light receiving regions rr7 and rr8. The tenth and twelfth light receiving regions rr10 and rr12 are disposed in a line in the radial direction X so as to be separated from each other. The twelfth light receiving region rr12 is disposed closer to the one radial direction X1 than the tenth light receiving region rr10 is.

In FIG. 10, the ninth and eleventh light receiving regions rr9 and rr11 are disposed at the upper right side, and the ninth light receiving region rr9 is disposed at the inner side than the eleventh light receiving region rr11. The tenth and twelfth light receiving regions rr10 and rr12 are disposed at the lower right side, and the tenth light receiving region rr10 is disposed at the inner side than the twelfth light receiving region rr12.

Thirteenth and fifteenth light receiving regions rr13 and rr15 are disposed closer to the other radial direction X2 than the first to fourth light receiving regions rr1, rr2, rr3, and rr4 are, and are also disposed so as to be separated from the first to fourth light receiving regions rr1, rr2, rr3, and rr4. In addition, the thirteenth and fifteenth light receiving regions rr13 and rr15 are disposed closer to the other tangential direction Y2 than the fifth and sixth light receiving regions rr5 and rr6 are, and are also disposed so as to be separated from the fifth and sixth light receiving regions rr5 and rr6. The thirteenth and fifteenth light receiving regions rr13 and rr15 are disposed in a line in the radial direction X so as to be separated from each other. The thirteenth light receiving region rr13 is disposed closer to the one radial direction X1 than the fifteenth light receiving region rr15 is.

Fourteenth and sixteenth light receiving regions rr14 and rr16 are disposed closer to the other radial direction X2 than the first to fourth light receiving regions rr1, rr2, rr3, and rr4 are, and are also disposed so as to be separated from the first to fourth light receiving regions rr1, rr2, rr3, and rr4. In addition, the fourteenth and sixteenth light receiving regions rr14 and rr16 are disposed closer to the one tangential direction Y1 than the fifth and sixth light receiving regions rr5 and rr6 are, and are also disposed so as to be separated from the fifth and sixth light receiving regions rr5 and rr6. The fourteenth and sixteenth light receiving regions rr14 and rr16 are disposed in a line in the radial direction X so as to be separated from each other. The fourteenth light receiving region rr14 is disposed closer to the one radial direction X1 than the sixteenth light receiving region rr16 is.

Referring to FIG. 10, the thirteenth and fifteenth light receiving regions rr13 and rr15 are disposed at the lower left side, and the thirteenth light receiving region rr13 is disposed at the inner side than the fifteenth light receiving region rr15. The fourteenth and sixteenth light receiving regions rr14 and rr16 are disposed at the upper left side, and the fourteenth light receiving region rr14 is disposed at the inner side than the sixteenth light receiving region rr16.

One of the ± first-order diffracted light beams from the first diffraction region dr1 enters the ninth light receiving region rr9, which is located at the inner side of the upper right part in FIG. 10, and the other of the ± first-order diffracted light beams from the first diffraction region dr1 enters the thirteenth light receiving region rr13, which is located at the inner side of the lower left part in FIG. 10. One of the ± first-order diffracted light beams from the second diffraction region dr2 enters the tenth light receiving region rr10, which is located at the inner side of the lower right part in FIG. 10, and the other of the ± first-order diffracted light beams from the second diffraction region dr2 enters the fourteenth light receiving region rr14, which is located at the inner side of the upper left part in FIG. 10. One of the ± first-order diffracted light beams from the fifth diffraction region dr5 enters the eleventh light receiving region rr11, which is located at the outer side of the upper right part in FIG. 10, and the other of the ± first-order diffracted light beams from the fifth diffraction region dr5 enters the fifteenth light receiving region rr15, which is located at the outer side of the lower left part in FIG. 10. One of the ± first-order diffracted light beams from the sixth diffraction region dr6 enters the twelfth light receiving region rr12, which is located at the outer side of the lower right part in FIG. 10, and the other of the ± first-order diffracted light beams from the sixth diffraction region dr6 enters the sixteenth light receiving region rr16, which is located at the outer side of the upper left part in FIG. 10.

In FIG. 10, the ninth light receiving region rr9, which is located at the inner side of the upper right part, and the thirteenth light receiving region rr13, which is located at the inner side of the lower left part, are connected in the inside, and outputs from these light receiving regions are added and are then transmitted to an objective lens shift signal generating section 84 to be described later. In FIG. 10, the tenth light receiving region rr10, which is located at the inner side of the lower right part, and the fourteenth light receiving region rr14, which is located at the inner side of the upper left part, are connected in the inside, and outputs from these light receiving regions are added and are then transmitted to the objective lens shift signal generating section 84 to be described later.

In FIG. 10, the eleventh light receiving region rr11, which is located at the outer side of the upper right part, and the fifteenth light receiving region rr15, which is located at the outer side of the lower left part, are connected in the inside, and outputs from these light receiving regions are added and are then transmitted to the objective lens shift signal generating section 84 to be described later. In FIG. 10, the twelfth light receiving region rr12, which is located at the outer side of the lower right part, and the sixteenth light receiving region rr16, which is located at the outer side of the upper left part, are connected in the inside, and outputs from these light receiving regions are added and are then transmitted to the objective lens shift signal generating section 84 to be described later.

As shown in FIG. 2, the control section 36 controls the rotation driving section 34 and the optical pickup device 20. Specifically, the control section 36 has a rotation control section which controls the rotation driving section 34 and an optical pickup control section which controls the optical pickup device 20. The rotation control section rotates the optical disk 26 by driving a spindle motor under control of the optical pickup control section.

The optical pickup control section is a reproduction control section which reproduces the information recorded on the optical disk 26 by controlling the optical pickup device 20. As shown in FIG. 3, the optical pickup control section includes a focus error signal generating section 88, a main push-pull signal generating section 92, the objective lens shift signal generating section 84, a track error signal generating section 93, and a reproduction signal generating section 94. The optical pickup control section has other functions for performing focusing servo, tracking servo, and the like, for example, the actuator 52 and a function for controlling the actuator 52.

The focus error signal generating section 88 generates a focus error signal FES on the basis of a signal outputted from a light receiving element for focusing, specifically, signals outputted from the fifth to eighth light receiving regions rr5, rr6, rr7, and rr8. Assuming that S5, S6, S7 and S8 denote output signals based on the light receiving amount in the fifth to eighth light receiving regions rr5, rr6, rr7, and rr8, respectively, the focus error signal generating section 88 generates a focus error signal by operation of (S5+S8)−(S6+S7).

The main push-pull signal generating section 92 generates a main push-pull signal on the basis of a signal outputted from a light receiving element for push-pull signals, specifically, signals outputted from the first to fourth light receiving regions rr1, rr2, rr3, and rr4. Assuming that S1, S2, S3 and S4 denote output signals based on the light receiving amount in the first to fourth light receiving regions rr1, rr2, rr3, and rr4, respectively, the main push-pull signal generating section 92 generates a main push-pull signal by operation of (S1+S2)−(S3+S4).

The objective lens shift signal generating section 84 generates an objective lens shift signal on the basis of a signal outputted from a light receiving element for objective lens shift signals, specifically, signals outputted from the ninth to sixteenth light receiving regions rr9 to rr16. Assuming that S9 denotes the sum of output signals from the ninth and thirteenth light receiving regions rr9 and rr13, S10 denotes the sum of output signals from the tenth and fourteenth light receiving regions rr10 and rr14, S11 denotes the sum of output signals from the eleventh and fifteenth light receiving regions rr11 and rr15, and S12 denotes the sum of output signals from the twelfth and sixteenth light receiving regions rr12 and rr16, the objective lens shift signal generating section 84 generates an objective lens shift signal by operation of (S9+S11)−(S10+S12).

The track error signal generating section 93 generates a track error signal on the basis of the main push-pull signal generated by the main push-pull signal generating section 92 and the objective lens shift signal generated by the objective lens shift signal generating section 84. Specifically, the track error signal generating section 93 generates a track error signal by operation of {(S1+S2)−(S3+S4)}−α{(S9+S11)−(S10+S12)}. Here, α is a predetermined coefficient, and is a value which is appropriately set on the basis of a result of experiment, statistics of tolerances at the time of manufacture or the like.

The reproduction signal generating section 94 generates a reproduction signal on the basis of the signal outputted from the light receiving element for push-pull signals. Specifically, the reproduction signal generating section 94 generates a reproduction signal by performing the operation of (S1+S2+S3+S4).

Here, the arrangement of the light receiving element for objective lens shift signals and the light receiving element for focusing will be described. When recording or reproducing the optical disk 26, a returning light beam from the recording layer 40 (called a recording layer which is not targeted) other than the recording layer 40 (called a target recording layer) which is a target of recording or reproduction of information may enter the light receiving region on the light receiving element 30.

For example, when reproducing the first recording layer 41, a returning light beam from the second recording layer 42 may enter the light receiving element 30 after being transmitted through a polarization hologram (zeroth-order diffraction).

If the returning light beam from the recording layer which is not targeted, which was zeroth-order-diffracted at the polarization hologram, enters the light receiving element for objective lens shift signals and the light receiving element for focusing which receive ± first-order diffracted light beams, the ratio of stray light to an optical signal increases. As a result, the S/N ratio is reduced.

Therefore, it is preferable to dispose the light receiving elements 30 at the positions where a possibility that the returning light beam from the recording layer which is not targeted will enter the light receiving element for objective lens shift signals and the light receiving element for focusing is low.

Specifically, assuming that f1 denotes the focal distance of the objective lens 28, f2 denotes the focal distance of the collimating lens 48, Dis denotes the distance of the recording layer 40 of the optical disk, and m denotes the refractive index of the light transmitting layer 38, the light receiving element for objective lens shift signals and the light receiving element for focusing are preferably disposed outside a circular region with a radius R2=(2×Dis/m)(f2/f1) having as the center an intersection between the optical axis of the zeroth-order diffracted light beam, which enters the light receiving element 30, and a substrate 95 of the light receiving element 30.

Through this configuration, it is possible to reduce a possibility that the returning light beam from the recording layer which is not targeted will enter the light receiving element 30. As a result, it is possible to reduce a possibility that the signal quality of a focus error signal and/or a track error signal will deteriorate due to the returning light beam from the recording layer which is not targeted.

In the case where the thickness of the light transmitting layer 38 is about 0.1 to 0.075 mm and an influence of the returning light beam on the light transmitting layer surface 46 is not negligible, it is preferable that the light receiving element for objective lens shift signals and the light receiving element for focusing are disposed at the positions where a possibility that the returning light beam on the light transmitting layer surface 46 will enter is low.

Specifically, assuming that f1 denotes the focal distance of the objective lens 28, f2 denotes the focal distance of the collimating lens 48, t denotes the maximum value of the thickness of the light transmitting layer 38, and m denotes the refractive index of the light transmitting layer 38, the light receiving element for objective lens shift signals and the light receiving element for focusing are preferably disposed outside a circular region with a radius R3=(2×t/n)(f2/f1) having as the center the intersection between the optical axis of the zeroth-order diffracted light beam, which enters the light receiving element 30, and the substrate 95 of the light receiving element 30.

The refractive index of the light transmitting layer 38 is 1.59, for example. The maximum value of the thickness of the light transmitting layer 38 refers to the distance between the light transmitting layer surface 46 and the recording layer 40, which is located farthest when viewed from the light incidence plane. Here, the layer distance between the light transmitting layer surface 46 and the first recording layer 41 is set to 0.1 mm.

Here, the reason why the maximum value t of the thickness of the light transmitting layer 38 is used is that the irradiation range of returning light beam from the light transmitting layer surface 46 on the light receiving element 30 increases when the thickness of the light transmitting layer 38 is larger (here, when reproducing the information on the first recording layer 41), taking the size of a spot on the light receiving element 30 of the returning light beam from the light transmitting layer surface 46 into consideration. In addition, a layer between the second recording layer 42 and the first recording layer 41 also serves as the light transmitting layer 38.

According to the present embodiment, the light receiving region 32 for focusing is formed in the light receiving element 30 as part of the plurality of light receiving regions. In the diffraction element 31, the diffraction regions 33 for focusing are formed as part of the plurality of diffraction regions. A part of a division line which defines the diffraction region 33 for focusing is formed in a shape which is convex from the outer side toward the inner side with respect to the center 62 of the incidence range on the diffraction element 31 where a returning light beam enters. The part of the division line formed in the shape which is convex from the outer side toward the inner side divides the incidence range 58 on the diffraction element 31 where a returning light beam enters, regardless of whether or not there is a focus error.

Accordingly, the diffraction region 33 for focusing can be formed in a notched shape by the convex part of the division line. In addition, the shape of the notched portion of the diffraction region 33 for focusing can be made as a shape which tapers from the outer side toward the inner side. When the distance from the objective lens 28 to the recording layer 40 of the optical disk changes in a range where focusing servo is performed, the incidence range 58 on the diffraction element 31 expands or contracts. Since the diffraction region 33 for focusing is formed in a notched shape by the part of the division line, the shape of a section perpendicular to the propagating direction of light diffracted in the diffraction region 33 for focusing can be made as a notched shape even if the incidence range 58 on the diffraction element 31 expands or contracts.

Accordingly, it is possible to suppress the situation where the ratio of the light intensity of light beam, which enters the light receiving region 32 for focusing, to the light intensity of all light beams, which enter the diffraction region, changes with the expansion or contraction of the incidence range 58 on the diffraction element 31, compared with the related art. Therefore, the light intensity of light beam used for focusing servo when the incidence range 58 on the diffraction element 31 expands and the light intensity of light beam used for focusing servo when the incidence range 58 on the diffraction element 31 contracts can be made equal.

As a result, it is possible to suppress the situation where a change of a focus error signal when the distance between the objective lens 28 and the optical disk 26 increases and decreases from the optimal value as a reference value becomes asymmetrical with respect to the optimal value. In this case, it is possible to suppress the situation where the focusing servo easily fails due to the asymmetry of the change of the focus error signal. Accordingly, stable focusing servo can be performed.

According to the present embodiment, the part of the division line includes the orthogonal line segment 66 and the inclined line segment 68. The orthogonal line segment 66 is perpendicular to the predetermined radius 69 for the center 62 of the incidence range, at the predetermined intersection 72. The inclined line segment 68 is a line segment which is connected with the orthogonal line segment 66 in a direction becoming distant from the center 62 of the incidence range. In addition, the inclined line segment 68 forms a part of a straight line, which crosses a straight line including the predetermined radius 69, at the side closer to the center 62 of the incidence range than the predetermined intersection 72 is.

Accordingly, the ratio of the light intensity of light beam entering the diffraction region 33 for focusing to the total light intensity of light beam entering the diffraction element 31 can be made equal in both the case where the incidence range 58 on the diffraction element 31 expands and the case where the incidence range 58 on the diffraction element 31 contracts. A portion, which is defined by the part of the division line formed in the convex shape, of the diffraction region adjacent to the diffraction region 33 for focusing, that is, an adjacent region has a shape which becomes wide from the center 62 of the incidence range toward the outer side, since the inclined line segment 68 is inclined with respect to the predetermined radius 69. Accordingly, if the incidence range 58 on the diffraction element 31 expands, the area of a portion where the incidence range 58 and the diffraction region 33 for focusing overlap each other increases, and the area of a portion where the incidence range 58 and the adjacent region overlap each other also increases. As a result, it is possible to suppress the situation where the ratio of the light intensity of light beam, which is used for focusing servo, to the light intensity of all returning light beams changes with an increase or decrease in the area of the incidence range 58.

In addition, according to the present embodiment, the part of the division line is formed in a shape symmetrical with respect to the straight line including the predetermined radius 69. Accordingly, in both the case where the incidence range 58 on the diffraction element 31 expands and the case where the incidence range 58 on the diffraction element 31 contracts, the ratio of the light intensity of light beam entering the diffraction region 33 for focusing to the total light intensity of light beam entering the diffraction element 31 can be similarly controlled at both sides of the straight line including the predetermined radius 69. As a result, in both the case where the incidence range 58 on the diffraction element 31 expands and the case where the incidence range 58 on the diffraction element 31 contracts, the light intensity of light beam used for focusing servo can be easily set.

In addition, according to the present embodiment, the diffraction region 33 for focusing includes two diffraction regions. The two diffraction regions are adjacent to each other with the diameter division line 63 interposed therebetween. The diameter division line 63 is perpendicular to the predetermined radius 69 at the center 62 of the incidence range. In this case, diffraction regions located at both sides of the diameter division line 63, that is, the third and fourth diffraction regions dr3 and dr4 can be used for focusing servo. Accordingly, the focusing servo can be performed using the double knife edge method.

In addition, according to the present embodiment, the part of the division line is formed in a shape symmetrical with respect to the straight line including the predetermined radius 69, and the diffraction region 33 for focusing is formed in a shape symmetrical with respect to the straight line including the diameter division line 63. The end of each inclined line segment 68 on the side far from the center 62 of the incidence range is connected with the parallel line segment 74 which is parallel to the diameter division line 63. The value obtained by dividing Da by DH is set to a value which is larger than 0.25 and smaller than 0.35, in which DH denotes a diameter of the incidence range 58 on the diffraction element 31 in a case of focusing on a recording surface of the optical disk, and Da denotes a distance between the center 62 of the incidence range and the straight line including the parallel line segment 74.

Accordingly, the light intensity of light beam used for focusing servo can be sufficiently ensured, and the ratio of the light intensity in the diffraction region 33 for focusing to the light intensity in the entire incidence range 58 can be easily controlled. By setting the value, which is obtained by dividing Da by DH, to the value exceeding 0.25, the light intensity of light beam used for focusing servo can be sufficiently ensured. In addition, by setting the value obtained by dividing Da by DH to the value smaller than 0.35, the adjacent region can be disposed at the position near the center 62 of the incidence range. Since the density of light beams at the position near the center of the incidence range 58 is larger than the density of light beams at the position near the outer edge, it becomes easy to control the ratio of the light intensity in the diffraction region 33 for focusing to the light intensity in the entire incidence range 58 by the increase or decrease in the area where the adjacent region and the incidence range 58 overlap each other. Accordingly, the precision of focusing servo can be sufficiently ensured.

In addition, according to the present embodiment, Da is set to be larger than Db, and the difference between Da and Db is set to be smaller than 5% of DH, in which Db denotes a distance between the center 62 of the incidence range and the predetermined intersection 72. As a result, in both the case where the incidence range 58 on the diffraction element 31 expands and the case where the incidence range 58 on the diffraction element 31 contracts, the light intensity of light beam entering the diffraction region 33 for focusing can be sufficiently ensured. Accordingly, it becomes easy to control the ratio of the light intensity in the diffraction region 33 for focusing to the light intensity in the entire incidence range 58. Thus, it is possible to easily suppress the asymmetry of the change of the focus error signal.

In addition, according to the present embodiment, the light receiving surface which receives at least part of the returning light beams is formed in each light receiving region. Light beams diffracted in the diffraction region 33 for focusing are convergent light beams. The convergent light beams are condensed such that the area of a section perpendicular to the propagating direction of the middle of light beams after diffraction becomes the minimum at the position deviated from the light receiving surface. The position where the area of the section of convergent light beams becomes the minimum deviates from the light receiving surface in a direction perpendicular to the light receiving surface. As a result, when performing the focusing servo using the knife edge method, the light intensities of light beams entering two light receiving regions, in which convergent light beams are received, can be made equal with high precision. In this way, the focusing servo can be performed with high precision.

In addition, according to the present embodiment, the light beams diffracted in the diffraction region 33 for focusing are convergent light beams whose area of the section perpendicular to the propagating direction of the middle of light beams after diffraction becomes the minimum at the side of the diffraction element 31 rather than the light receiving surface. The distance between the position, at which the area of the section of light beam after diffraction becomes the minimum, and the light receiving surface is set to be larger than 50 μm and smaller than 100 μm. Accordingly, the focusing servo can be performed with high precision using the knife edge method, and it is possible to suppress the situation where the ratio of the light intensity of light beam, which enters the diffraction region 33 for focusing, to the light intensity of the entire incidence range 58 changes with expansion and contraction of the incidence range 58 on the diffraction element 31.

In addition, according to the present embodiment, the optical disk device 21 includes the optical pickup device 20, the rotation driving section 34, and the control section 36. The rotation driving section 34 rotates the optical disk 26, and the control section 36 controls the optical pickup device 20 and the rotation driving section 34. As a result, it is possible to suppress the situation where a change of a focus error signal becomes asymmetrical with respect to the optimal value even if the distance between the objective lens 28 and the optical disk 26 increases and decreases from the optimal value as a reference value. In this case, it is possible to suppress the situation where the focusing servo easily fails due to the asymmetry of the change of the focus error signal. As a result, stable focusing servo can be performed.

In addition, according to the present embodiment, assuming that Db denotes the distance between the straight line including the parallel line segment 74, which is parallel to the diameter division line 63, and the center 62 of the incidence range, the value obtained by dividing Db by DH is set to a value which is larger than 0.25 and smaller than 0.3. Accordingly, the light intensity of light beam used for focusing servo can be sufficiently ensured, and the area where the incidence range 58 and the adjacent region overlap each other can be sufficiently ensured. Specifically, by setting the value, which is obtained by dividing Db by DH, to the value exceeding 0.25, the light intensity of light beam used for focusing servo can be sufficiently ensured. In addition, by setting the value obtained by dividing Db by DH to the value smaller than 0.35, it is possible to sufficiently ensure the area where the incidence range 58 and the adjacent region overlap each other. Accordingly, it is possible to suppress the situation where the ratio of the light intensity in the diffraction region 33 for focusing to the light intensity in the entire incidence range 58 changes largely with expansion and contraction of the incidence range 58 on the diffraction element 31.

Although the arrangement in which the returning light beam from the light transmitting layer surface 46 does not enter the light receiving element for objective lens shift signals and the light receiving element for focusing was described in the above, it is preferable to dispose at least the light receiving element for objective lens shift signals outside the circular region with a radius R3=(2×t/n)(f2/f1).

The reason is that even if a returning light beam reflected on the light transmitting layer surface 46 enters the light receiving element for focusing, the focus error signal FES becomes (S5+δA+S8+δB)−(S6+δC+S7+δD) when a changed part caused by the amount of returning light beam on the light transmitting layer surface 46 is expressed with δ attached, and accordingly, an influence of returning light beam reflected on the light transmitting layer surface 46 is canceled since δA≈δC and δB≈δD.

On the other hand, in the case of the light receiving element for objective lens shift signals, the objective lens shift signal becomes (S9+δE+S11+δF)−(S10+δG+S12+δH). Accordingly, increase and decrease of δG and δH become opposite to δE and δF. Specifically, the values of δG and δH are negative if the values of δE and δF are positive, and the values of δG and δH are positive if the values of δE and δF are negative. This indicates that the influence of returning light beam reflected on the light transmitting layer surface 46 is not canceled.

For this reason, if the position of returning light beam on the light transmitting layer surface 46 moves on the light receiving element for objective lens shift signals when the objective lens 28 shifts, offset easily occurs in the objective lens shift signal compared with the focus error signal FES. Therefore, it is preferable to dispose the light receiving element for objective lens shift signals outside the circular region with the radius R3=(2×t/m)(f2/f1).

In addition, the light receiving element for focusing is not easily influenced by a returning light beam, compared with the light receiving element for objective lens shift signals. However, if the thickness of the light transmitting layer 38 varies by several micrometers from 100 μm as a reference, the irradiation range and the intensity of returning light beam from the light transmitting layer surface 46 on the light receiving element 30 change. This becomes a disturbance for the focus error signal. From this point of view, it is preferable that the returning light beam on the light transmitting layer surface 46 is not received by the light receiving element for focusing.

The optical disk device 21 of the present embodiment includes an element which reproduces the information recorded on an optical information recording medium on the basis of a reproduction signal, in addition to the optical pickup device 20, the rotation driving section 34, and the control section 36.

In addition, in another embodiment, the focus error signal generating section 88 may be configured to calculate the ideal state signal value 78 by computation. By the configuration of the diffraction element 31, the median value 76 of the signal range for focusing and the ideal state signal value 78 are made to be equal. Accordingly, if the ideal state signal value 78 is further calculated by computation, positional deviation can be offset by computation even if the positional deviation occurs in the relative position of the diffraction element 31 and the light receiving element 30 according to temporal change, for example. Since the range of positional deviation which can be offset can be enlarged compared with the configuration where the positional deviation is offset only by computation, it is possible to form an optical pickup device which is durable to the temporal change.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical pickup device comprising:
a light source that emits a light beam toward a recording layer of an optical disk;
an objective lens that condenses the light beam emitted from the light source onto the recording layer of the optical disk;
a light receiving element having a plurality of light receiving regions where a returning light beam after being emitted from the light source and reflected on the recording layer of the optical disk is received, each of the light receiving region carrying out output corresponding to the received light intensity and light receiving regions for focusing which are used for focusing servo being formed as part of the plurality of light receiving regions; and
a diffraction element having a plurality of diffraction regions formed by being divided by a division line, each of the diffraction regions diffracting at least part of returning light beams toward the corresponding light receiving region among the plurality of light receiving regions and diffraction regions for focusing which diffract at least part of the returning light beams toward the light receiving regions for focusing being formed as part of the plurality of diffraction regions,
part of a division line which defines the diffraction region for focusing being formed in a shape which is convex from an outer side toward an inner side with respect to a center of an incidence range on the diffraction element where a returning light beam enters, and
the part of the division line formed in a shape which is convex from the outer side toward the inner side dividing the incidence range on the diffraction element where a returning light beam enters, regardless of whether or not there is a focus error.

2. The optical pickup device of claim 1, wherein the part of the division line includes an orthogonal line segment perpendicular to a radius which is predetermined with respect to a center of the incidence range, at a predetermined intersection and an inclined line segment that is connected with the orthogonal line segment in a direction becoming distant from the center of the incidence range and that forms a part of a straight line, which crosses a straight line including the predetermined radius, at a side closer to the center of the incidence range than the predetermined intersection is.

3. The optical pickup device of claim 2, wherein the part of the division line is formed in a shape symmetrical with respect to the straight line including the predetermined radius.

4. The optical pickup device of claim 2, wherein the diffraction region for focusing includes two diffraction regions, and
the two diffraction regions are adjacent to each other with a diameter division line, which is perpendicular to the predetermined radius at the center of the incidence range, interposed therebetween.

5. The optical pickup device of claim 4, wherein the part of the division line is formed in a shape symmetrical with respect to a straight line including the predetermined radius,
the diffraction region for focusing is formed in a shape symmetrical with respect to a straight line including the diameter division line, and
an end of the inclined line segment on a side far from the center of the incidence range is connected with a parallel line segment which is parallel to the diameter division line, and
a value obtained by dividing Da by DH is set to a value which is larger than 0.25 and smaller than 0.35, in which DH denotes a diameter of the incidence range on the diffraction element in a case of focusing on a recording surface of the optical disk, and Da denotes a distance between the center of the incidence range and a straight line including the parallel line segment.

6. The optical pickup device of claim 5, wherein Da is set to be larger than Db, and a difference between Da and Db is set to be smaller than 5% of DH, in which Db denotes a distance between the center of the incidence range and the predetermined intersection.

7. The optical pickup device of claim 1, wherein a light receiving surface which receives at least part of returning light beams is formed in the light receiving region, and
light beams diffracted in the diffraction region for focusing may be convergent light beams condensed such that the area of a section perpendicular to the propagating direction of the middle of light beams after diffraction becomes the minimum at the position deviated from the light receiving surface in a direction perpendicular to the light receiving surface.

8. The optical pickup device of claim 7, wherein the light beams diffracted in the diffraction region for focusing are convergent light beams whose area of the section perpendicular to the propagating direction of the middle of light beams after diffraction becomes a minimum at the side of the diffraction element rather than the light receiving surface, and
the distance between the position, at which the area of the section of light beam after diffraction becomes the minimum, and the light receiving surface may be set to be larger than 50 μm and smaller than 100 μm.

9. An optical disk device comprising:
the optical pickup device of claim 1;
a rotation driving section that rotates the optical disk; and
a control section that controls the optical pickup device and the rotation driving section.
